(19) United States
(12) Patent Application Publication
(10) Pub. No.: US 2025/0336022 A1
(43) Pub. Date: Oct. 30, 2025

(54) METHOD AND SYSTEM FOR WATERMARKING IMAGES, AND METHOD AND SYSTEM FOR DETECTING A WATERMARK IN AN IMAGE

(71) Applicant: City University of Hong Kong, Kowloon (HK)

(72) Inventors: Antoni Bert Chan, Kowloon (HK); Feiyu Chen, Kowloon (HK); Ziquan Liu, London (GB)

(21) Appl. No.: 18/646,105

(22) Filed: Apr. 25, 2024

(51) Int. Cl. G06T 1/00

(52) U.S. Cl. CPC G06T 1/0064; G06T 1/0028

(57) ABSTRACT

A computer-implemented method for watermarking images includes providing a secret key network (SKN) that is adapted to output a standard multivariate normal (SMVN) distribution for a given input image distribution, applying an input image to the SKN, generating a secret key signature (SKS) as a real vector, and embedding a watermark in the input image by using an adversarial attack to modify the input image in a manner that aligns the SKN's output with the SKS. A computer-implemented method for detecting a watermark in an image is also provided.

### TECHNICAL FIELD

The present invention relates to methods and systems for watermarking images and methods and systems for detecting a watermark in an image.

### BACKGROUND

The strong capability of image-editing models has led to unauthorized alterations of images, infringing on the original creators' or owners' intellectual property rights. Additionally, the introduction of generative image models with realistic outputs has made it challenging for people to discern the authenticity of images [28]. One effective way to address both issues is through image watermarking [4, 26], where unique identifiers are imposed onto the image through imperceptible modifications, thus keeping the aesthetics of the image. In the 1st case, the image owner can confirm ownership by extracting the owner's watermark from the altered image. In the 2nd case, a watermark can be inserted into images produced by a generative image model, and an image consumer can later extract the watermark to obtain the image's provenance.

Most existing watermarking methods are based on either: 1) traditional methods [5, 9, 29, 41], which can provide nice theoretical guarantees on detector performance but are less secure due to their usage of known linear embedding functions; or 2) deep learning methods [1, 11, 15, 21, 22, 43] that use non-linear embedding/detection functions (deep neural networks, DNNs) to improve detection performance, but do not have any detection guarantees. Furthermore, because these encoder/decoder frameworks are trained end-to-end, the mechanisms learned to embed and detect the watermark are obfuscated. However, if the DNNs used are kept secret (i.e., not publicly available), then the security of the watermark is high.

### SUMMARY OF THE INVENTION

Imperceptible watermarks are essential in safeguarding the content authenticity and the rights of creators in imagery. Recently, several leading approaches, notably zero-bit watermarking, have demonstrated impressive imperceptibility and robustness in image watermarking. However, these methods have security weaknesses, e.g., the risk of counterfeiting and the ease of erasing an existing watermark with another watermark, while also lacking a statistical guarantee regarding the detection performance. To address this issue, some embodiments of the invention propose a novel framework to train a secret key network (SKN), which serves as a non-duplicable safeguard for securing the embedded watermark. The SKN is trained so that natural images' output obeys a standard multi-variate normal distribution. To embed a watermark, an adversarial attack (a modified PGD attack) is applied on the image such that the SKN produces a secret key signature (SKS) with a longer length. Then two hypothesis tests are derived to detect the presence of the watermark in an image via the SKN response magnitude and the SKS angle, which offer a statistical guarantee of a false positive rate. The proposed framework maintains robustness comparable to existing methods and excels in security and imperceptibility.

According to a first aspect of the invention, there is provided a computer-implemented method for watermarking images, which includes providing a secret key network (SKN) that is adapted to output a standard multivariate normal (SMVN) distribution for a given input image distribution, applying an input image to the SKN, generating a secret key signature (SKS) as a real vector, and embedding a watermark in the input image by using an adversarial attack to modify the input image in a manner that aligns the SKN's output with the SKS.

In some embodiments, the step of providing the SKN may include training a deep neural network (DNN) to function as the SKN via a generation loss (Gen-Loss) which is designed to train the SKN's output to follow an SMVN distribution.

In some embodiments, the SKN may serve as a unique, non-linear mapping function.

In some embodiments, the SKN may be based on a modified ResNet18 architecture with linear activation in its final layer to map the input image to the real vector.

In some embodiments, the SKS may follow normal distribution properties and have a cosine value greater than 0 with an angle formed with an output vector of the input image.

In some embodiments, in the step of embedding the watermark, the SKN's output may be made in the same direction as the SKS, with a length extended such that it is unlikely to be a sample from the SMVN.

In some embodiments, the step of embedding the watermark may further include adjusting a length and an angle of the SKN output to match predefined targets via a watermarking loss (WM-Loss) and the adversarial attack.

In some embodiments, the step of adjusting the length and the angle of the SKN output may include extending the length of the SKN output toward a length target and minimizing the angle between the SKN output and the SKS to be a target cosine value.

In some embodiments, the adversarial attack may iteratively add a gradient value computed by the WM-loss and clipped within a boundary limited by a scale factor into the watermarked image.

In a second aspect of the invention, there is provided a computer-implemented method for detecting a watermark in an image, which includes applying a secret key network (SKN) to a potentially watermarked image to extract a recovered signature, and performing statistical hypothesis tests on a length and an angle of the recovered signature to determine the watermark's presence in the potentially watermarked image. The potentially watermarked image is watermarked by the aforementioned computer-implemented method for watermarking images.

In some embodiments, the statistical hypothesis tests may include two hypothesis tests. The two hypothesis tests may include a first hypothesis test to work on the length of the recovered signature, testing if the vector is unlikely to be a sample from the SMVN, and a second hypothesis test to work on the angle, testing if the direction of the recovered signature matches the original SKS.

In some embodiments, the first hypothesis test may access the uniqueness of the SKN by calculating a first probability of the output vector not following the SMVN distribution, and the second hypothesis test may verify the uniqueness of the SKS by calculating a second probability of the output vector and the SKS having the same direction.

In some embodiments, the computer-implemented method may further include a step of statistically determining a probability of false positives in watermark detection.

In some embodiments, the step of statistically determining the probability of false positives may include obtaining a combined probability of the first probability and the second probability, and determining if the combined probability is smaller than a predefined significance level, wherein the predefined significance level represents a false positive rate.

In some embodiments, determining the combined probability to be smaller than the predefined significance level indicates successful detection of the watermark's presence.

According to a third aspect of the invention, there is provided a system for watermarking images, which includes one or more processors, and a memory storing one or more programs configured to be executed by the one or more processors, the one or more programs including instructions for performing or facilitating performing of the computer-implemented method as aforementioned.

According to a fourth aspect of the invention, there is provided a non-transitory computer readable medium having instructions stored thereon which, when executed by one or more processors, cause the one or more processors to execute the computer-implemented method for watermarking images as aforementioned.

According to a fifth aspect of the invention, there is provided a system for detecting an watermark in an image, which includes one or more processors, and a memory storing one or more programs configured to be executed by the one or more processors, the one or more programs including instructions for performing or facilitating performing of the computer-implemented method for detecting an watermark in an image as aforementioned.

According to a sixth aspect of the invention, there is provided a non-transitory computer readable medium having instructions stored thereon which, when executed by one or more processors, cause the one or more processors to execute the computer-implemented method for detecting an watermark in an image as aforementioned.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIGS. 1A to 1C show a secret-key watermarking framework according to an embodiment of the invention.

FIG. 2 shows an example of an imperceptible watermarking according to an embodiment of the invention.

FIGS. 3A to 3D show qualitative results for assessing normality: FIG. 3A and FIG. 3B show an average covariance matrix; and FIG. 3C and FIG. 3D show an estimated probability density function (PDF) using kernel density estimation (KDE). FIG. 3A and FIG. 3C are the results of training w/ [symbol] ᵥ, while FIG. 3B and FIG. 3D are trained w/o [symbol] ᵥ.

FIGS. 4A to 4E show robustness comparison of watermarking methods to various distortions: FIG. 4A shows Gaussian noise, FIG. 4B shows Gaussian blur, FIG. 4C shows cropping, FIG. 4D shows rotation, and FIG. 4E shows JPEG compression. For each type of distortion, its parameters are varied and the success detection rate is calculated.

FIG. 5 shows effect of different adversarial attacks on robustness to rotation and cropping. “G” represents an approach using a direct gradient value, while “S” signifies using a gradient sign.

FIG. 6 shows effect of watermarking with and without target length values in adversarial loss L adv, and only using the angle metric.

FIGS. 7A and 7B show effect of data augmentation module on watermarking.

FIGS. 8A to 8C show violin distribution of three p-value metrics for three different signature generation methods.

FIGS. 9A to 9I present qualitative comparison of watermark imperceptibility at two PSNR levels, 32 and 42, with HiDDeN, DNNOB and SSLWM.

FIGS. 10A to 10F present examples of watermarking using the proposed method according to an embodiment of the invention. Watermarking is performed with two specified PSNR target values: PSNR=32 and PSNR=42, respectively.

FIGS. 11A to 11E show effect of different adversarial attacks on robustness. “G” represents an approach using a direct gradient value, while “S” signifies using a gradient sign. Its parameters are varied for each type of distortion and the success detection rate is calculated.

FIG. 12 shows effect of perturbation intensities of Adversarial Attacks on Detection Rate and Image Quality. The detection rate is quantified by the proportion of images with p-values lower than 0.05, while image quality is assessed using PSNR.

FIGS. 13A to 13E show effect of watermarking with and without target length values in adversarial loss L adv, and only using the angle metric.

FIGS. 14A to 14E show effect of data augmentation module on watermarking.

FIG. 15 shows an example information handling system in some embodiments of the invention.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Hereinafter, some embodiments of the invention will be described in detail with reference to the drawings.

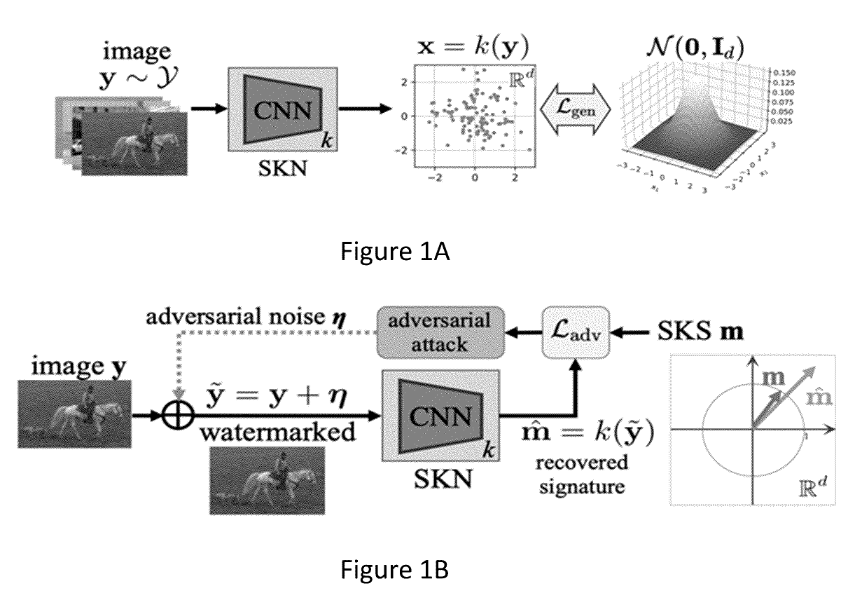

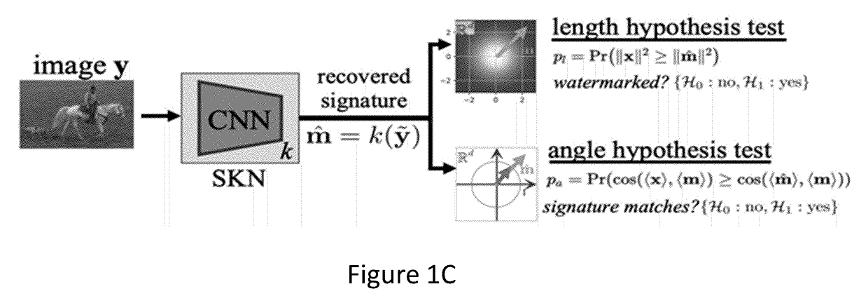

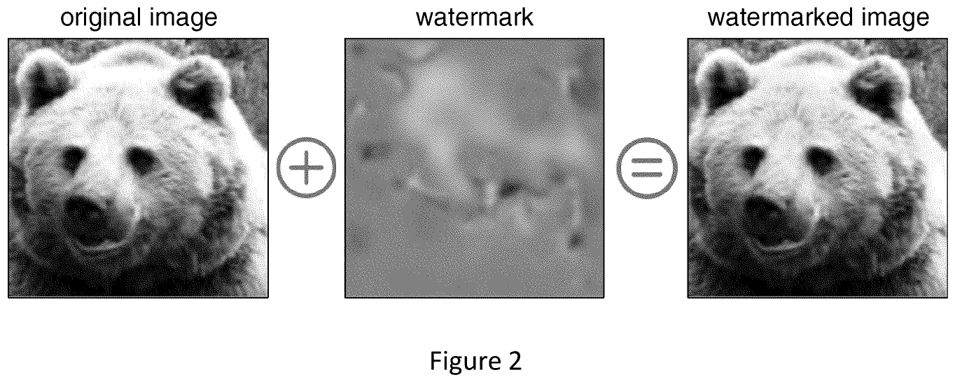

To simultaneously obtain a high detection rate, high invisibility, and high secrecy, some embodiments of the invention propose a new watermarking framework that combines a statistical detection framework with a secret-key DNN and adversarial attack (see FIGS. 1A to 1C). FIG. 1A illustrates secret key network (SKN) generation, FIG. 1B illustrates watermark embedding, and FIG. 1C illustrates watermark detection: the SKN is trained so that its output follows a standard multi-variate normal (SMVN) distribution given an input image distribution (FIG. 1A); given an image, a watermark is generated using adversarial attack that makes the SKN output the desired secret key signature (SKS) with extended length (FIG. 1B); the signature is recovered by applying the SKN to the image, and the watermark is detected using hypothesis tests derived from the assumed SMVN distribution of the SKN (FIG. 1C).

Specifically, a DNN (a non-linear function mapping from an image to a vector) is trained to imbue its output with known statistical properties. This DNN is denoted as a secret key network (SKN). To watermark an image, adversarial attack is then used on the SKN so that the adversarial image produces a desired secret key signature (SKS), a unique vector identifier. Watermark detection is achieved using hypothesis tests, which leverage the statistical properties of the trained SKN, providing both statistical guarantees and interpretability of the detector. The trained SKN is unique and kept secret, ensuring the security of the watermark, and its nonlinear mapping allows for a high detection rate.

Experiments assess three key factors in watermarking performance: imperceptibility, robustness, and security. Table 1 compares a method according to a preferred embodiment of the invention (hereinafter “proposed method”) with other zero-bit techniques, namely DNN0B and SSLWM [8]. Three potential security threats to watermarking are addressed through targeted experiments, and the results indicate that the proposed method significantly enhances security. The security of the proposed framework stems from each SKN's uniqueness, which enables watermarked images generated by one SKN (Model A) to be undetectable by another SKN (Model B) with the same architecture but different weights. For imperceptibility, the quality of watermarked images is compared to their originals. For the same target PSNR of 32, the proposed method surpasses others in image quality metrics, such as SSIM. In terms of robustness, the proposed method achieves comparable detection rates to other methods when the watermarked images undergo different perturbations. Finally, experiments also verify that the well-trained SKN has obtained the required normality in its output, which is important for the statistical guarantee (calibration) of the hypothesis tests, while other methods do not obtain such verification.

TABLE 1
Summary of comparisons with other zero-bit methods: assessing watermarking on
security, imperceptibility, and robustness. “False Rate” is the success
percentage of fake signatures (generated randomly or via the watermarking model)
that match true embedded signatures of watermarked images. “Resistance Level”
denotes the number of watermarks that can be recursively embedded before the
detection rate of the first watermark falls below 50%. “Avg DR” is
the average detection rate for each image distortion across various parameters.

| Property | Test Case | Metric | DNN0B | SSLWM | Ours |
|---|---|---|---|---|---|
| Security | Random-fake | False Rate ↓ | 0.08% | 12.84% | 1.94% |
| | Model-fake | False Rate ↓ | 100% | 100% | 4% |
| | WM-Remove | Resistance Level ↑ | 2 | 3 | 5 |
| Imperceptibility | Image Quality | SSIM ↑ | 0.9103 | 0.9026 | 0.9768 |
| Robustness | Gaussian noise | Avg DR ↑ | 92.20% | 40.88% | 99.02% |
| | Gaussian blur | | 81.88% | 88.33% | 99.40% |
| | Rotation | | 84.36% | 86.43% | 85.89% |
| | Cropping | | 97.90% | 85.51% | 90.58% |
| | JPEG | | 95.65% | 78.12% | 99.22% |

In summary, some technical effects achieved by the proposed method are as follows:
1. The proposed method introduces a new framework using adversarial attack for watermarking, integrating the advantages of traditional and deep learning techniques.
2. The proposed method proposes to train a secret-key network (SKN) to serve as the non-linear mapping function for watermarking images, whose outputs are imbued with known statistical properties. In the detection phase, two hypothesis tests are proposed, on the length and on the angle, for detecting SKN and SKS in watermarked images. The hypothesis tests offer a statistical guarantee, as well as explainability of the detector.
3. The experiment shows that the proposed method produces more imperceptible and secure watermarks while maintaining robustness against image distortions.

Next, the watermarking techniques and adversarial attacks (AAs) that are utilized in some embodiments of the invention are introduced.

### 1. Watermarking Techniques

Imperceptible watermarking aims to embed unique identifiers into images and is crucial in protecting image copyrights and verifying an image's provenance [35].

Traditional methods. Most traditional methods are based in the frequency domain, e.g., leveraging the FourierMellin transform [25], discrete Wavelet transform [17], or SVD-based transform [3]. Although frequency-based approaches often obtain better hiding ability and robustness, some works explore more direct approaches in the spatial domain (e.g., [41]). Compared to traditional methods, some embodiments of the invention embed watermarks in the spatial domain by subtly modifying the image's pixels using adversarial attacks (AA) on DNNs. The DNN essentially serves as a non-linear embedding function for the watermark, and the imperceptibility is guaranteed through AA's perturbation constraint.

Deep learning methods. Recently, convolutional neural networks (CNNs) have been applied to watermark images using end-to-end frameworks. HiDDeN is an end-to-end trained CNN that uses encoder and decoder networks to embed and extract the watermark. Subsequent works enhanced robustness through training with simulated image attacks [1, 22] and 2-stage training [21]. Recent works also modify generative image models to produce watermarked images [7, 36, 42]. Wen et al. embeds a watermark by modifying each denoising step of the diffusion model. A related area is steganography, which aims to hide a secret message inside an image [2, 11, 15, 37, 40]. While these works obtain good performance and secrecy, since the trained encoder/decoder CNN pairs are unique, their watermark detectors lack statistical guarantees and interpretability due to the black-box nature of end-to-end trained CNNs. In contrast, some embodiments of the invention maintain high security due to the uniquely trained CNN, while also offering detector interpretability and statistical guarantees due to hypothesis testing approach. In terms of architecture, previous deep learning methods use encoder/decoder CNN pairs to embed and extract the watermark. In contrast, some embodiments of the invention use a single CNN as a non-linear extraction function and an adversarial attack on the CNN as the embedding function.

Zero-bit watermarking. Most of the aforementioned methods assume the hidden watermark as a message composed of words or bits. In contrast, “zero-bit” (ZB) watermarking is only concerned with detecting a watermark's presence or absence without message recovery [5, 9, 29]. Traditional methods for ZB watermarking embed a real vector (a key signature) into the image using a linear embedding function (e.g., frequency-domain transformations) and then derive theoretically optimal methods for detecting the presence/absence of the watermark, contrasting with other methods [1, 22, 43] that use a binary vector to represent a message and use a decoder to recover it. Some works [8, 33, 34] replace the linear embedding/extracting function for ZB watermarking with a CNN pre-trained on the ImageNet image classification task, where the feature vector in the penultimate layer serves as the embedding space for the vector signature.

Some other works [8, 33, 34] use an adversarial attack to embed the signature into the image. However, there are three crucial differences regarding security, capability, and detector guarantees. First, ZB methods are based on known embedding functions (either linear frequency transforms or pre-trained CNNs), which leaves them vulnerable to signature forgery or signature overwriting, and thus lack security. In contrast, some embodiments of the invention regard the DNN itself as a secret key (i.e., SKN), which enhances the framework's security. Distinct SKNs can be generated based on different random seeds, and the signatures embedded with one SKN are unrecognizable by another SKN, maintaining the detectability of the original watermark even after multiple overlaps.

Second, some embodiments of the invention employ two types of signatures, the network SKN and the vector SKS, which provide two complementary methods to secretly embed information into the image via the SKN's output length and output direction. Correspondingly, two complementary hypothesis tests are used, based on length and angle, to detect the watermark. In contrast, ZB watermarking only uses a single vector signature and an angle hypothesis test. Thus, some embodiments of the invention have more capabilities, e.g., the proposed method could also be used for steganography, where the SKS is used to convey the message, and the SKN serves as the secret key. Third, because the SKNs are trained to adhere to an output Gaussian distribution, better-calibrated detector guarantees are obtained than the pre-trained CNN approaches [8, 33, 34], where they can only approximate a Gaussian distribution by matching the 1st and 2nd moments via feature whitening.

### 2. Adversarial Attacks (AA)

AAs aim to inject subtle noise into an image in order to alter the prediction of a DNN, e.g., to produce a misclassification [19, 23, 39]. The concept of an adversary can extend to improving the robustness of watermarking techniques. [22] uses adversarial samples in the DNN's training stage to enhance model robustness against a set of image distortions, ensuring accurate watermark detection. Adversarial noise is also employed defensively [13, 32], safeguarding images, particularly facial photos, against malicious edits by generative models. [14] leverages adversarial training to find the optimal position and transparency of visible watermarks for copy protection. In contrast to these methods, some embodiments of the invention leverage AA to generate the watermark as adversarial noise directly. More details about AA are presented hereinafter.

Adversarial Examples. An adversarial attack, Projected Gradient Descent (PGD) [23], is employed for a watermarking backbone. The PGD attack generates adversarial examples by iteratively tweaking the noise n and adding it to input data to maximize the adversarial loss while keeping changes imperceptibly small. The perturbation n is updated for each iteration t using gradient ascent,

$${η}_{t + 1} = {η}_{t} + α \cdot sign {∇}_{y} ℒ ( f ( y ) , {y}_{target} ) .$$

Here [symbol] (f(y),y_{target}) represents the adversarial loss, where f(·) is a specific DNN model, y is the input image, and y_{target} is the ground truth for a task. Meanwhile, ∇y [symbol] denotes the gradient computation based on the input image y. Subsequently, nₜ₊₁ is projected into an ∈-bound to guarantee that the pixel values of the image do not vary beyond the specified range, thus the adversarial noise is imperceptible. After completing all the iterations T, the perturbation nr will be added to the image y to produce its corresponding adversarial example.

### I. Watermarking Framework

According to some embodiments of the invention, a Secure Image Watermarking Framework (SIWF) is designed to address the critical challenges arising from unauthorized alterations of images and the difficulty in discerning the authenticity of images produced by some image-editing models. This proposed framework stands out for its capability to effectively watermarking images with imperceptible modifications, and secure and robust watermark identification even though someone tries to fake and remove existing watermark and images are distorted.

Unlike existing solutions, the SIWF offers integrating deep learning techniques. This includes training a deep neural network (DNN) as a secret-key network (SKN) to project images into a vector space, generating a real vector as a secret key signature (SKS), and embedding a watermark in an image by using adversarial attacks such that the SKN's output is aligned with a predefined SKS, and two statistical detection methods to provide a robust significant level for the verification of watermarks.

Designed specifically for content creators, digital rights managers, and image distribution platforms, this framework can enhance the security for the process of image authentication and rights management. It achieves this through just using an DNN as encoder, discarding the use of DNNs based on encoder-decoder structure for watermarking images, and designing two hypothesis tests to guarantee the uniqueness of two identifiers, SKN and SKS, in the detection stage.

In summary, the SIWF is a novel solution based on deep learning and statistics, promising to make a substantial impact in digital rights management, content authenticity verification, and intellectual property protection. With its focus on enhanced security, improved invisibility and advanced robustness.

In this section, some embodiments of the invention propose a new watermarking framework that combines a statistical detection framework with a secret-key DNN and adversarial attack. As summarized in FIGS. 1A to 1C, the framework is composed of three stages: 1) secret key network generation; 2) watermark embedding; 3) watermark detection. In the first stage (FIG. 1A), a DNN is trained as a secret key network (SKN) so that its output distribution is a standard multivariate normal (SMVN) distribution when given an input distribution of clean images. In the watermark embedding stage (FIG. 1B), an image is applied as the input to the SKN and an adversarial attack is used on the image to create the watermarked image. A secret key signature (SKS) is generated as a unit vector, which serves as a unique identifier for the watermark. The goal of the adversarial attack is to make the SKN output in the same direction as the SKS, with the length, extended such that it is unlikely to be a sample from the SMVN. In the watermark detection stage (FIG. 1C), the SKN is applied to the image, the recovered signature is extracted, and then two complementary hypothesis tests are used to detect the presence of the watermark. The first hypothesis test works on the length of the recovered signature (denoted as HT4L), testing if the vector is unlikely to be a sample from the assumed SMVN for typical images. The second hypothesis test works on the angle (HT4A), testing if the direction of the recovered signature matches the original SKS.

Note that the proposed framework has two secret keys: a well-trained CNN whose output vector should follow an SMVN distribution (SKN) and a real vector (SKS). Next, each stage will be described in detail.

### 1. Secret Key Network Generation

This stage involves training a deep neural network (DNN) to function as a secret key network (SKN). This network produces a standard multivariate normal (SMVN) distribution output when fed a distribution of clean images. For the SKN architecture, some embodiments of the invention select ResNet18 and modify its final fully-connected layer to use linear activation, thus enabling a mapping from an input image y∈ [symbol] to a real vector x∈ [symbol] . Here, d represents the dimension of the watermark space (e.g., 32), and n is the size of the image. Given an input distribution of images [symbol] , we require that the SKN output follows an SMVN distribution, i.e., x=k(y)˜ [symbol] (0, I_{d}), y˜ [symbol] . To achieve this, the parameters θ of SKN k(·) are trained to minimize the loss (i.e., the loss function termed Gen-Loss),

$${ℒ}_{g e n} = {λ}_{1} {ℒ}_{w} + {λ}_{2} {ℒ}_{v} \qquad ( 1. )$$

where [symbol] w is the Wasserstein loss between the output distribution and the SMVN, [symbol] ᵥ is a loss on the output variances, and λ₁, λ₂ are corresponding weighting hyperparameters.

Specifically, loss [symbol] _{w} steers the output vector x to follow the desired SMVN distribution and is based on the Wasserstein distance between two distributions,

$${ℒ}_{w} = {μ}_{d}^{T} {μ}_{d} + tr ( {\sum }_{d} ) + d - 2 tr ( {\sum }_{d}^{\frac{1}{2}} ) , \qquad ( 2. )$$

where (μ_{d}, Σ_{d}) are the mean and covariance of k(y) for a mini-batch {y}⊂ [symbol] . The second loss [symbol] ᵥ improves the convergence of each dimension of x to unit variance,

$${ℒ}_{v} = {‖ diag ( {\sum }_{d} ) - {1}_{d} ‖}_{1} , \qquad ( 3. )$$

where diag(·) extracts the diagonal of the matrix, 1_{d} is the d-dimensional vector of ones, and ∥·∥₁ is the L1-norm.

Equation (2) is proven as follows. When given two multivariate normal distributions q, p with mean vectors μ_{q}, μₚ and covariance matrices Σ_{q}, Σₚ, the Wasserstein distance [symbol] from [6] is

$$𝒲 [ q , p ] = {‖ {μ}_{q} - {μ}_{p} ‖}^{2} + tr ( {\sum }_{q} ) + tr ( {\sum }_{p} ) - 2 t r ( {( {\sum }_{q} {\sum }_{p} )}^{1 / 2} ) \qquad ( 4 )$$

where tr is the trace operator. This expression is also called Fréchet distance. Another common expression for the Wasserstein distance from [10, 24] is written as

$$𝒲 [ q , p ] = {‖ {μ}_{q} - {μ}_{p} ‖}^{2} + tr ( {\sum }_{q} ) + tr ( {\sum }_{p} ) - 2 t r ( {( {\sum }_{q}^{1 / 2} {\sum }_{p} {\sum }_{q}^{1 / 2} )}^{1 / 2} ) \qquad ( 5 )$$

The equivalence between (1) and (2) can be proved by noting that:

$$t r ( {( {\sum }_{p}^{1 / 2} {\sum }_{q} {\sum }_{p}^{1 / 2} )}^{1 / 2} ) = tr ( {( {\sum }_{p}^{1 / 2} {\sum }_{q} {\sum }_{p}^{1 / 2} )}^{1 / 2} {\sum }_{p}^{- 1 / 2} {\sum }_{p}^{1 / 2} ) = tr ( {\sum }_{p}^{1 / 2} {( {\sum }_{p}^{1 / 2} {\sum }_{q} {\sum }_{p}^{1 / 2} )}^{1 / 2} {\sum }_{p}^{- 1 / 2} ) . \qquad ( 6 )$$

Then we have

$${( {\sum }_{p}^{1 / 2} {( {\sum }_{p}^{1 / 2} {\sum }_{q} {\sum }_{p}^{1 / 2} )}^{1 / 2} {\sum }_{p}^{- 1 / 2} )}^{2} = {\sum }_{p} {\sum }_{q} \qquad ( 7 )$$

Therefore, (4) and (5) are equivalent.

For the convenience of computation, the form of (4) is chosen. Assuming a target distribution is a standard multivariate normal distribution [symbol] (0, I_{d}) in [symbol] , then (4) becomes,

$${ℒ}_{c} = {μ}_{d}^{T} {μ}_{d} + tr ( {\sum }_{d} ) + d - 2 tr ( {\sum }_{d}^{\frac{1}{2}} ) .$$

Large image datasets (e.g., MSCOCO [20]) are used for training the SKN. Note that k(·) defines a secret non-linear manifold space in which the watermark is embedded. SKNs generated with different architectures or initial seeds will result in different non-linear manifold spaces. Some embodiments of the invention select ResNet18 for the SKN since it is an efficient and uncomplicated CNN, and other architectures could also be used.

Next, a Secret Key Signature (SKS) is generated as a user's watermark identifier. The generation algorithm ensures that the signature follows normal distribution properties and has a cosine value greater than 0 with the angle formed with the output vector of the clean image. In an embodiment of the invention, a method of generating signatures, named “aligned signatures” is provided. First, a real vector m is generated as a user's watermark identifier. The m is subject to the properties of a normal distribution, denoted as S˜ [symbol] (μ, σ²), with μ and σ² representing the mean and variance of the distribution, respectively. Here, the μ is a zero vector and σ² is an identity matrix. Secondly, the alignment criterion necessitates that the cosine of an angle θ between the m and the SKN output m is positive. Mathematically, this criterion is expressed as cos(θ)>0, where θ is the angle formed between m and m. The cosine of the angle can be calculated using the dot product of m and \hat{m}, normalized by the magnitudes of the two vectors:

$$cos ( θ ) = \frac{m \cdot \hat{m}}{‖ m ‖ ‖ \hat{m} ‖}$$

Finally, if the cos(θ)>θ, the randomly generated m needs the alignment criterion and the m is the Secret Key Signature (SKS); while if the cos(θ)<0, it is necessary to align the direction of m with the one of \hat{m} and the −m as the SKS.

### 2. Watermark Embedding

With the well-trained SKN, the adversarial attack is used to create the watermark by adding imperceptible noise into an image. In the framework, the watermarking should achieve two goals simultaneously. First, the AA watermark should make the SKN produce an output vector that is unlikely to be drawn from its assumed SMVN (for clean images)—the longer the output vector, the more unlikely it is, and thus the stronger the watermark. Second, the AA should make the SKN output vector in the same direction as the SKS.

Specifically, given an image y, the watermark is embedded using AA on k(y), resulting in the watermarked image \tilde{y}=y+η, where n is the adversarial noise. To achieve the two design goals on the SKN output \hat{m}=k(\tilde{y}) for the adversarial image, a specific adversarial loss is devised,

$${f}_{a d v} = {{λ}_{3} ( {‖ \hat{m} ‖}_{2}^{2} - {t}_{l} )}^{2} + {{λ}_{4} ( {t}_{a} - cos ( \hat{m} , m ) )}^{2} , \qquad ( 8 )$$

where the 1st term (denoted as [symbol] ₗₑₙ) controls the length of \hat{m} to match a target length tₗ, and the 2nd term (denoted as [symbol] _{agl}) controls the angle between \hat{m} and SKS m to be a target cosine value tₐ, and λ₃, λ₄ are the loss weights. In practice, the target length is set as tₗ=63 (equivalent to p=10⁻⁴ in the length hypothesis test), and tₐ=1 is set so that the angle between \hat{m} and m is shrunk to 0.

Some embodiments of the invention use a modified version of PGD as the AA for watermarking images, where the gradient value (instead of its sign) is used to update the adversarial noise. The perturbation ∈-bound is measured with L₂-norm, which is equivalent to mean-squared error and related to PSNR. Thus, ∈ directly controls the PSNR of the watermarked image. In addition, to further improve the robustness of the watermark to image transformations, a data augmentation module (DA) from [8, 33, 34] is adapted into the watermarking process.

In other words, this stage involves watermarking an image using the SKS and SKN. An image y is input into the SKN, and a new loss,

$$ℒ = {{λ}_{3} ( {‖ \hat{m} ‖}_{2}^{2} - {t}_{l} )}^{2} + {{λ}_{4} ( {t}_{a} - cos ( \hat{m} , m ) )}^{2} ,$$

termed watermarking loss (WM-Loss), is computed (see equation 8 above). This loss adjusts the output vector \hat{m} to lengthen towards a length target tₗ and minimize the angle with the SKS vector m, related to tₐ. The iterative process is described as ηₜ₊₁=ηₜ+α·∇ₗ [symbol] , where α is the updating scale. ηₜ₊₁ is then projected within an ϵ-bound to maintain image pixel values within a specified range, which can be described as ηₜ₊₁=β·ηₜ₊₁. And the β is the scale factor to modify ηₜ₊₁ dependent on

$$β = clip ( \sqrt{{β}_{tg} / mean ( {η}_{t + 1}^{2} )} , 0 , 1 )$$

where β_{tg} is a given target. The gradient value ηₜ is added as a watermark to the input (clean) image y to produce the watermarked image \tilde{y}.

### 3. Watermark Detection

Hypothesis testing is a fundamental procedure in statistics used to determine whether there is enough evidence in a sample of data to generalize a population parameter. It involves two main hypotheses: null hypothesis [symbol] ₀ and alternative hypothesis [symbol] ₁. The outcome is to either reject [symbol] ₀ or fail to reject it based on the evidence presented by the sample. For this purpose, a test statistic ξ, which summarizes the sample data, must be calculated at first and assumed to follow a specific distribution when [symbol] ₀ is true. The p-value is then determined as the probability of obtaining the ξ at least as extreme as the one that was observed under the [symbol] ₀. Finally, [symbol] ₀ is rejected in favor of [symbol] ₁ if this p-value is less than a predetermined significance level α.

Note that the threshold a acts as a benchmark for decision-making and is conventionally set at 0.05, and it delineates the boundary between the rejection and acceptance regions for [symbol] ₀. Besides, the significance level is directly associated with the false positive error in hypothesis testing, which means the error occurs when the [symbol] ₀ is true, but the test incorrectly rejects it.

To detect the watermark in an image \tilde{y}, the SKN is applied to the image to obtain the recovered signature \hat{m}=k(\tilde{y}) Some embodiments of the invention propose two hypothesis tests focusing on length and angle metrics (denoted as HT4L and HT4A) to confirm that the watermark was generated by the SKN-SKS pair.

HT4L. Since the SKN output for clean images follows an SMVN, a hypothesis test is devised to detect the presence of a watermark produced by the SKN. The null hypothesis [symbol] ₀ is that the image does not contain a watermark (the \hat{m} is a sample from the SMVN), and the alternative hypothesis [symbol] ₁ is that the image contains a watermark (\hat{m} is unlikely to be a sample from the SMVN). Since x is distributed as an SMVN, the test statistic is ∥x∥² and follows a χ² distribution with d degrees of freedom, and the p-value of observing a test statistic as extreme as ∥\hat{m}∥², i.e., pₗ=Pr(∥x∥²≥∥\hat{m}∥²), can be calculated as [38]

$${p}_{l} = 1 - {\int }_{0}^{\vert {‖ \hat{m} ‖}^{2}} \frac{1}{{2}^{d / 2} Γ ( d / 2 )} {t}^{d / 2 - 1} {e}^{- t / 2} dt , \qquad ( 9 )$$

where the Γ(d/2) is the gamma function [18].

HT4A. Some embodiments of the invention devise a hypothesis test that the recovered signature vector \hat{m} matches the pre-defined SKS m. Here, the null hypothesis [symbol] ₀ is that m and m do not match directions (as they are randomly sampled from the SMVN), while the alternative hypothesis [symbol] ₁ is that they have the same direction. The test statistic is the normalized vec tor [symbol] x [symbol] =x/∥x∥, which ideally follows a uniform distribution on the unit hypersphere S^{d-1}, and thus the p value of observing [symbol] m [symbol] or better can be derived, pₐ=Pr(cos( [symbol] x [symbol] , [symbol] m [symbol] )≥cos( [symbol] x [symbol] , [symbol] m [symbol] )). By using multifold integration and the geometry of high-dimensional spheres, the p-value can be derived,

$${p}_{a} = 1 - \frac{1}{π} [ θ - cos θ {\sum }_{k = 1}^{\frac{d - 2}{2}} \frac{( 2 k - 2 ) ! !}{( 2 k - 1 ) ! !} {sin}^{( 2 k - 1 )} ( θ ) ] , \qquad ( 10 )$$

where θ=arccos( [symbol] m [symbol] , [symbol] \hat{m} [symbol] ) is the angle between m, \hat{m}.

Equation (10) is proven as follows. Given that

$$X ∼ N ( 0 , {I}_{d} ) , \qquad ( 11 )$$

$$we have$$

$$\frac{X}{‖ X ‖} ∼ U ( {S}_{d - 1} ) , \qquad ( 12 )$$

$$where$$

$${S}_{d - 1} = \frac{d \times {π}^{d / 2}}{Γ ( \frac{d}{2} + 1 )} \qquad ( 13 )$$

is the whole surface area in a unit sphere in the d dimensional domain.

The p-value for the angle is given by

$$\begin{matrix}p = {\int }_{cos ( w , x ) ⩽ c} U ( {S}_{d - 1} ) dx \\ = U ( {S}_{d - 1} ) {\int }_{cos ( w , x ) ⩽ c} 1 dx\end{matrix} . \qquad ( 14 )$$

From the geometric explanation, the part

$${\int }_{cos ( w , x ) ⩽ c} 1 dx \qquad ( 15 )$$

represents a solid angle Ω in an d-dimensional sphere.

Because the d-dimensional sphere is a unit one, the p-value formula becomes:

$$p = 1 - \frac{surface area of Ω}{{S}_{d - 1}} \qquad ( 16 )$$

We have the relationship:

$${S}_{d - 1} = g ( r ) \times {\int }_{0}^{π} {sin}^{( d - 2 )} ( {ϕ}_{1} ) d {ϕ}_{1} \times {\int }_{0}^{π} {sin}^{d - 3} ( {ϕ}_{2} ) d {ϕ}_{2} … \times {\int }_{0}^{π} sin ( {ϕ}_{d - 2} ) d {ϕ}_{d - 2} \times {\int }_{0}^{2 π} d {ϕ}_{d - 1} \qquad ( 17 )$$

where g(r) is the part of computation about radius r.

For the solid angle Ω, we have:

$${S}_{Ω} = g ( r ) \times {\int }_{0}^{θ} {sin}^{( d - 2 )} ( {ϕ}_{1} ) d {ϕ}_{1} \times {\int }_{0}^{π} {sin}^{d - 3} ( {ϕ}_{2} ) d {ϕ}_{2} … \times {\int }_{0}^{π} sin ( {ϕ}_{d - 2} ) d {ϕ}_{d - 2} \times {\int }_{0}^{2 π} d {ϕ}_{d - 1} . \qquad ( 18 )$$

Thus, the probability becomes:

$$P = 1 - \frac{{\int }_{0}^{θ} {sin}^{d - 2} ( {ϕ}_{1} ) d {ϕ}_{1}}{2 {\int }_{0}^{\frac{π}{2}} {sin}^{d - 2} ( {ϕ}_{1} ) d {ϕ}_{1}} . \qquad ( 19 )$$

For the numerator expression, given that the length of the outputted feature is 32, an even number, the formula for d being even is:

$${\int }_{0}^{π} {sin}^{d - 2} ( {ϕ}_{1} ) d {ϕ}_{1} = 2 {\int }_{0}^{\frac{π}{2}} {sin}^{d - 2} ( {ϕ}_{1} ) d {ϕ}_{1} = \frac{( d - 3 ) !!}{( d - 2 ) !!} \cdot π . \qquad ( 20 )$$

And for the denominator expression, we have

$$2 {\int }_{0}^{\frac{θ}{2}} {sin}^{d - 2} ( {ϕ}_{1} ) d {ϕ}_{1} = \frac{( d - 3 ) !!}{( d - 2 ) !!} θ - \frac{( d - 3 ) !!}{( d - 2 ) !!} cos θ {\sum }_{k = 1}^{\frac{d - 2}{2}} \frac{( 2 k - 2 ) !!}{( 2 k - 1 ) !!} {sin}^{2 k - 1} ( θ ) . \qquad ( 21 )$$

Substitute (20) and (21) into (16), and in the end, we obtain

$$P = 1 - \frac{θ - cos θ {\sum }_{k = 1}^{\frac{d - 2}{2}} \frac{( 2 k - 2 ) !!}{( 2 k - 1 ) !!} {sin}^{( 2 k - 1 )} ( θ )}{π} . \qquad ( 22 )$$

Combined hypothesis test. Combining the p-values pₗ, pₐ can test whether the image is watermarked by SKN k with SKS m. Using the combination method from [31], the p-value for the combined hypothesis test is

$${p}_{c} = {p}_{l} \cdot {p}_{a} \cdot ( 1 - ln ( ( {p}_{l} \cdot {p}_{a} ) ) . \qquad ( 23 )$$

Statistical guarantees. If the calculated p-value (e.g., p_{c}) is less than a predetermined significance level α (usually 0.05), then we reject the null hypothesis [symbol] ₀ (watermark absent) in favor of the alternative hypothesis [symbol] ₁ (watermark present). The significance level α acts as a benchmark for decision-making and is equal to the false positive (Type I) error rate, i.e., detecting the watermark even though none is actually present. Thus by selecting α, we can obtain a watermark detector with a certain false positive rate.

In summary, this stage involves applying the SKN to a potentially watermarked image to extract a recovered signature. Two hypothesis tests, HT4L and HT4A, are proposed to detect and identify a user's watermark. HT4L assesses the uniqueness of the user's SKN by calculating the probability of the output vector not following an SMVN distribution. The probability is computed as

$${p}_{l} = 1 - {\int }_{0}^{{‖ \hat{m} ‖}^{2}} \frac{1}{{2}^{d / 2} Γ ( d / 2 )} {t}^{d / 2 - 1} {e}^{- t / 2} dt$$

where d is the dimension of the SKS and Γ(·) is the gamma function. HT4A verifies the uniqueness of the user's SKS by calculating the probability of the output vector and SKS having the same direction. This is measured by the probability of the angle's cosine value between two vectors, with the formula

$${p}_{a} = 1 - \frac{1}{π} [ θ - cos θ {\sum }_{k = 1}^{\frac{d - 2}{2}} \frac{( 2 k - 2 ) !!}{( 2 k - 1 ) !!} {sin}^{( 2 k - 1 )} ( θ ) ] ,$$

where θ=arccos(m, \hat{m}). Additionally, the combined probability p_{c}=pₗ·pₐ·(1−ln((pₗ·pₐ)) is computed. When p_{c} is smaller than a predefined significance level α, it indicates successful detection of the user's watermark, with a representing the false positive rate.

The proposed method primarily employs two types of hypothesis testing for watermark detection, each founded on distinct properties of the normal distribution. Specifically, the hypothesis test for SKN utilizes the characteristic outlined in Prop. 1, and the one for SKS is aligned with Prop. 2.

Property 1 Suppose X is a d-dimensional standard normal random vector, i.e., x˜ [symbol] (0_{d}, Iₐ), where I_{d} is the k dimensional identity matrix and all its components are independent standard normal random variables. Under this assumption, each

$${x}_{i}^{2}$$

(where i=1, 2, . . . , d) follows a standard chi-squared distribution with 1 degree of freedom. Hence, their sum,

$${\sum }_{i} {x}_{i}^{2} = {x}^{T} x ,$$

is chi-squared (χ²) distributed with d degrees of freedom.

Property 2 Consider a Gaussian random vector x in [symbol] . Assume it has the distribution: x˜ [symbol] (0d, I_{d}). Under this assumption, the probability density function (PDF) for the transformation

$$y = \frac{x}{‖ x ‖}$$

can be determined. Due to the Gaussian distribution's rotational symmetry, y is uniformly distributed on the (d−1)-dimensional unit hypersphere, denoted [symbol] _{d-1} in [symbol] .

### II. Experiments

This section provides demonstration of the effectiveness of the proposed approach through various experiments, including SKN normality (II-2), detection performance (II-3), imperceptibility (II-4), robustness (II-5), and security (II-6). Ablation studies are also conducted as in II-7. A summary of important results is presented in Tab. 1.

### 1. Experimental Setup

MSCOCO is chosen as training and test dataset, which is also adopted by the baselines [8, 34, 43]. MSCOCO comprises 118k training images and 5k test images. ResNet18 is adopted as the SKN while changing its output layer to contain 32 neurons with linear activations. The SKN is trained on the MSCOCO training set. Detailed training parameters can be found as follows.

Experimental Setup: PyTorch version 2.0 and Python 3.9, with the RTX 3090 GPU are used for both the training and testing phases.

SKN Model Architecture: Resnet18 is selected as the backbone for the proposed model. To adapt it to the proposed approach, the input layer at the beginning of the model is modified to a kernel size of 3, and the subsequent max-pooling is removed. After processing through all residual blocks, the feature map goes through an adaptive average pooling, resulting in a 4×4 output size. The final fully-connection layer outputs 32 dimensions. The remainder of our model aligns with the standard Resnet18 architecture.

SKN Training Procedure: For SKN training, the MSCOCO is utilized. Images are initially resized to 160×160 and then randomly cropped to 128×128 before feeding into the model. The training batches consisted of 256 images each. The training epochs are 15. The optimizer is Adam, with a learning rate of 0.001 for the first 5 epochs and 0.0001 for the remaining 10. Initial weights of the model are randomly assigned. The weights of two terms in the training function [symbol] _{gen} in (1) are set to λ₁=1 and λ₂=2.5.

Testing Procedure: In the testing phase, individual images are processed one at a time. The PGD adversarial attack settings included a perturbation bound of ∈=0.00063, with 100 iterations and a step size of 0.01. The weights in the adversarial loss [symbol] _{adv} in (8) are set to λ₃=0.1 and λ₄=200.

| Hypothesis Test 1 Testing xⱼ ~ [symbol] (μ, σ²) ? | |
|---|---|
| STEP 1: Define hypotheses, | |
| [symbol] : xⱼ ~ [symbol] (μ, σ²); | |
| [symbol] : xⱼ + [symbol] (μ, σ²) | |
| STEP 2: Sample from the dataset, | |
| Samples m = 5000; | |
| STEP 3: Construct statistic | |
| $D = {sup}_{i ∈ \{ {m}_{j} \}} \vert {ECDF}_{m} ( i ) - CDF ( i ; μ , {σ}^{2} ) \vert$ | (24) |
| STEP 4: Because D follows Kolmogorov distribution, | |
| P-value p can be computed by | |
| $p = 2 {\sum }_{k = 1}^{∞} {( - 1 )}^{k - 1} {e}^{- 2 {k}^{2} {D}^{2}} .$ | (25) |

STEP 5: Set the confidence α and get conclusion. If the p < α,
reject the [symbol] and accept [symbol] ; Otherwise accept the [symbol] .

| Hypothesis Test 2 Testing μ_{d} = 0_{d} ? | |
|---|---|
| STEP 1: Define hypotheses, | |
| [symbol] : μ_{d} = 0_{d}; | |
| [symbol] : μ_{d} ≠ 0_{d}. | |
| STEP 2: Sample from the dataset, | |
| Samples m = 100, variables d = 32. | |
| STEP 3: Construct statistic | |
| $ξ = \frac{m ( m - d )}{d ( m - 1 )} {\overline{μ}}_{d}^{T} {S}_{d}^{- 1} {\overline{μ}}_{d} .$ | (26) |
| STEP 4: Because ξ ~ F(d, m − d), P-value p can be computed by | |
| $p = 1 - {\int }_{0}^{{ξ}^{′}} {{t}^{d / 2 - 1} ( 1 - t )}^{( m - d ) / 2 - 1} dt ,$ | (27) |
| ${ξ}^{′} = \frac{d \cdot ξ}{d \cdot ξ + m - d} .$ | (28) |

STEP 5: Set the confidence α and get conclusion. If the p < α,
reject the [symbol] and accept [symbol] ; Otherwise accept the [symbol] .

For a given image, the SKS is generated to be in the same semi-hemispherical domain in the 32-dimensional space as the natural response of the SKN, i.e., their angle is less than 180 degrees. Generating the SKS in this way ensures that the AA does not need to perform drastic changes to the image, ensuring watermark invisibility and maintaining image corruption within the specified range. This enhances the watermark detection accuracy without increasing the false detection rate as shown in ablation study provided below.

Three distinct approaches are utilized to create signatures. The first approach is to sample a 32-dimensional vector from the SMVN distribution directly, and this is called as the “naïve signature”. In the second approach, the generated signature must adhere to a normal distribution and be orthogonal in any direction to the output vector of SKN for a specific image, thereby ensuring the initial non-correlation between SKS and the output vector. Signatures produced in this way are referred as “orthogonal signatures”. The third approach also demands that the signature follows the normal distribution properties, but it must have a cosine value greater than 0 with the angle formed with the output vector. These are denoted as “aligned signatures”.

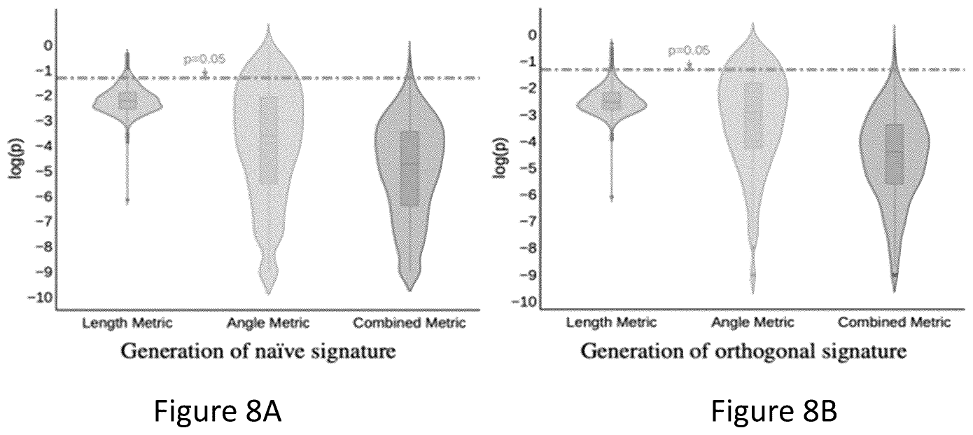

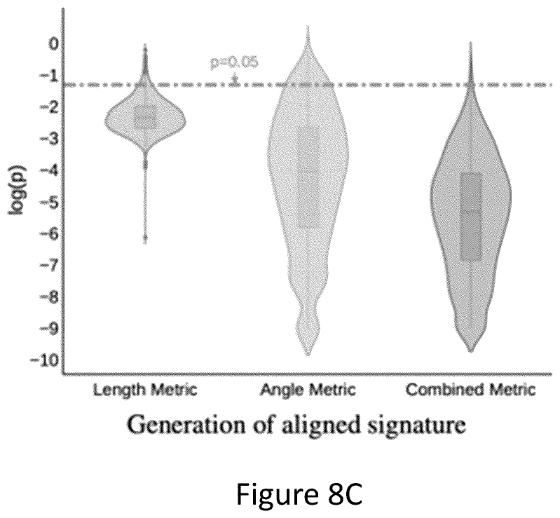

In the experiment, the watermark detection performance of different signature generation methods is evaluated via their p-values for length, angle, and their combined measures. Tab. 8 presents the mean and standard deviation, as well as the percentages of p-values falling below 0.05 and 0.01 thresholds. These findings indicate that aligned signatures achieve the lowest p-values, attributed to their lower mean, smaller standard deviation, and a higher proportion of samples below the 0.05 and 0.01 thresholds compared to other methods. For a clearer visualization, FIG. 8 displays the distribution of these p-values. The violin plots reveal a significant deviation of watermarked images' p-values from the 0.05 threshold, particularly notable in angle and combined p-values when using aligned signatures.

TABLE 8
Watermark detection performance for different signature generation
methods. The mean and standard deviation (std) of the detector's
p-values are shown, as well as the percentage of p-values below
significance level α = 0.05 and α = 0.01.

| | | | |
|---|---|---|---|
| mean | std | <0.05 | <0.01 |

naïve signatures

| | | | | |
|---|---|---|---|---|
| Length | 0.0139 | 0.0277 | 0.9468 | 0.6778 |
| Angle | 0.0305 | 0.0953 | 0.8724 | 0.7634 |
| Combine | 0.0020 | 0.0119 | 0.9918 | 0.9660 |

orthogonal signatures

| | | | | |
|---|---|---|---|---|
| Length | 0.0074 | 0.0184 | 0.9788 | 0.8454 |
| Angle | 0.0284 | 0.0709 | 0.8536 | 0.7034 |
| Combine | 0.0024 | 0.0172 | 0.9914 | 0.9632 |

aligned signatures

| | | | | |
|---|---|---|---|---|
| Length | 0.0124 | 0.0291 | 0.9568 | 0.7308 |
| Angle | 0.0109 | 0.0376 | 0.9358 | 0.8514 |
| Combine | 0.0011 | 0.0091 | 0.9948 | 0.9828 |

For the AA, the modified PGD is used with L₂ perturbation bound with ∈=6.3×10⁻⁴, corresponding to an average PSNR of 32 for the watermarked images. The success detection rate (SDR) is measured by computing the percentage of successfully detected watermarked images over all the test images (each test image is watermarked). A successful detection refers to a watermark image that obtains a p-value from the hypothesis test that is lower than the specified confidence level. Image quality is also measured using PSNR, SSIM, MAE, and RMSE.

The proposed method is compared with three recent deep-learning methods: HiDDeN [43], zero-bit watermarking with DNNs (DNN0B) and its self-supervised variant (SSLWM) [8]. To calculate the SDR for DNN0B and SSLWM, the significance level is set at 0.05, aligning with commonly used statistical thresholds. HiDDeN operates differently since it embeds bit strings as the watermark [43] defines a successful watermark detection as having a bit error rate lower than 0.05 (a level deemed correctable in communication transmissions).

### 2. Normality of the SKN

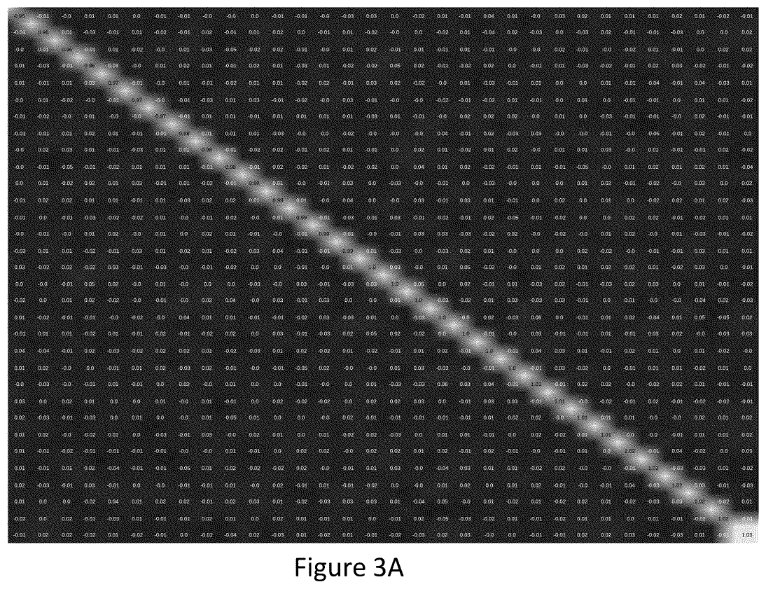

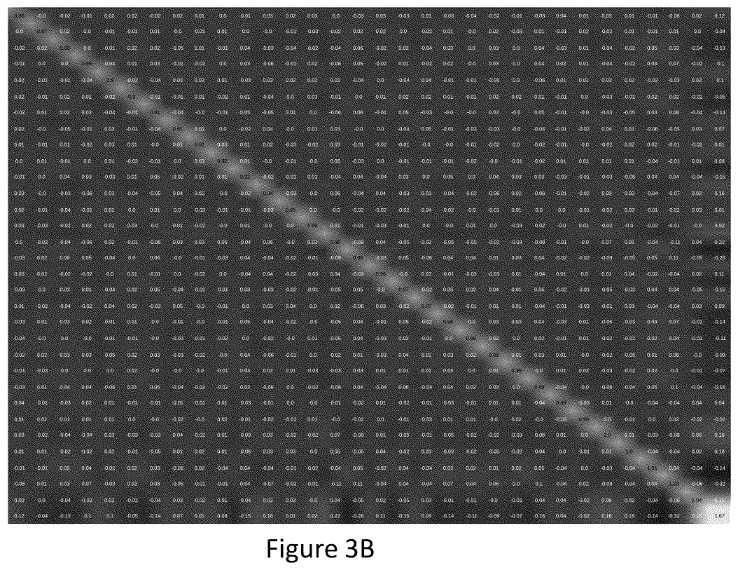

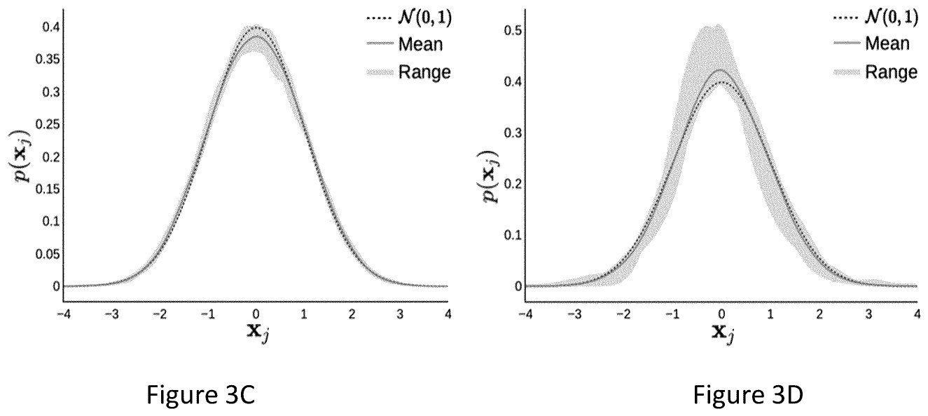

The normality of the SKN's output after training is assessed by examining the covariance matrix and mean vector of the outputs. The test dataset is divided into 50 batches, each with 100 images, and the covariance matrix and mean vector of the SKN outputs for each batch are calculated. The average covariance matrix over all batches is visualized in FIG. 3A, and resembles an identity matrix. Kernel density estimation (KDE) is used to approximate the PDF of each dimension of x, and then the average, Minimum, and maximum of the 32 estimated PDFs are plotted in FIG. 3C. The plots show that the individual output dimensions will follow a standard normal distribution.

The effect of the proposed variance loss term [symbol] ᵥ is also evaluated by using a similar analysis on an SKN trained without [symbol] ᵥ. The results are denoted by “w/o [symbol] ᵥ”, and are presented in FIGS. 3B and 3D, and Tab. 2 (right). The absence of [symbol] ᵥ during SKN training led to a noticeable deviation from normality in the output vector, as seen by a covariance matrix not resembling an identity matrix, and a PDFs significantly deviating from standard normal distributions.

Finally, three hypothesis tests are conducted on a batch of images to examine whether every entry in the output vector follows a normal distribution, whether the mean vector is zero, and whether the covariance matrix is identity. The results in Tab. 3 show that our SKNs obtain normality in each dimension, and the loss term [symbol] ᵥ is required to achieve this. Furthermore, similar tests are conducted on the output features of DNNOB and SSLWM, and it is found that they cannot achieve normality since they only use a whitening matrix to linearly transform the feature space of the pre-trained CNN.

TABLE 2
Quantitative results of assessing normality. Var †and
Cov ^{†} are the diagonal and off-diagonal entries in
the covariance matrix of the outputs, and mean * are the
entries of the mean vector. Across all batches and output
dimensions, we compute the mean and standard deviation (std).

| | |
|---|---|
| w/ [symbol] ᵥ | w/o [symbol] _{V} |

| | mean | std | mean | std |
|---|---|---|---|---|
| Var ^{†} | 0.9984 | 0.0200 | 1.4181 | 0.2687 |
| Cov ^{†} | −0.0002 | 0.0017 | 0.0022 | 0.1103 |
| mean * | −0.0019 | 0.0186 | −0.0015 | 0.0471 |

TABLE 3
Hypothesis testing on the SKN output distribution. (a) the
percentage of entries in the output vector that exhibit normality
according to the Kolmogorov-Smirnov test. (b) the acceptance
rate of the null hypothesis that the mean vector is zero,
and (c) that the covariance matrix is identity.

| Hypo. Test | Ours | Ours [symbol] ᵥ | DNN0B [34] | SSLWM [8] |
|---|---|---|---|---|
| (a) normality | 96.88% | 71.88% | 10.16% | 3.71% |
| (b) zero mean | 100% | 100% | 84% | 0% |
| (c) identity cov. | 67% | 27% | 0% | 0% |

The principal steps for each hypothesis test (H.T.) applied are outlined above to evaluate the normality of the trained SKN's output. Initially, H.T. 1 is employed to determine if a dataset adheres to a normal distribution by comparing the distribution of the sample data with the expected normal distribution. However, this test is limited to a single variable. In the experiment, each entry of the output vector is separately examined and then the proportion of entries contributing to the acceptance of [symbol] ₀ is calculated. As defined in [25], ECDFₘ(·) represents the empirical cumulative distribution function of the m samples, while CDF(·) signifies the target cumulative distribution function. The target distribution is the normal distribution characterized by mean μ and variance σ², expressed as CDF (i; μ, σ²) for the i-th sample.

While H.T. 1 assesses normality, it does not specifically evaluate standard normality. To address this, two additional hypothesis tests are performed: one to determine if the mean vector equals the zero vector (outlined in H.T. 2), and another to check if the covariance matrix is the identity matrix (described in H.T. 3). Specifically, the A in (30) is the sample deviation matrix, derived from the sample covariance matrix S in (31). The test dataset is segmented into 500 batches of 100 images each. Each batch serves as a set of test samples for the hypothesis test, and we calculate the proportion of batches that do not reject the null hypotheses [symbol] ₀.

| Hypothesis Test 3 Testing Σ_{d} = I_{d} ? | |
|---|---|
| STEP 1: Define hypotheses, | |
| [symbol] : Σ_{d} = I_{d}; | |
| [symbol] : Σ_{d} ≠ I_{d}. | |
| STEP 2: Sample from the dataset, | |
| Samples m = 100, variables d = 32. | |
| STEP 3: Construct statistic | |
| ξ = tr(A) − m · ln \|A\| − m · d · (1 − ln m), | (29) |
| A = m · S_{d}. | (30) |
| $STEP 4 : Because ξ ∼ {χ}^{2} ( {d}^{′} ) with {d}^{′} = \frac{d ( d + 1 )}{2} ,$ | |
| P-value p can be computed by | |
| $p = 1 - {\int }_{0}^{{ξ}^{2}} \frac{1}{{2}^{{d}^{′} / 2} Γ ( {d}^{′} / 2 )} {t}^{{d}^{′} / 2 - 1} {e}^{- t / 2} dt$ | (31) |

STEP 5: Set the confidence α and get conclusion. If the p < α,
reject the [symbol] and accept [symbol] ; Otherwise accept the [symbol] .

### 3. Detection Performance

Next the performance of the detector's hypothesis tests is analyzed. The mean and standard deviation of the three p-values (pₗ, pₐ, and p_{c}) is calculated across all watermarked images, and the percentage of p-values below significance levels of 0.05 and 0.01 is recorded. Additionally, these results are compared with those from clean images to highlight the detection performance and verify a false positive error rate. The results are presented in Tab. 4, revealing successful watermarking, which is evident from the low mean p-values and nearly 100% detection rate on watermarked images. The results on clean images confirm a false positive rate that matches the desired significance level, illustrating the soundness of the proposed method.

TABLE 4
Watermark detection performance. For both watermarked and
clean images, the mean and standard deviation (std) of the
detector's p-values are shown, as well as the percentage
of p-values below significance level α = 0.05 and α = 0.01.

| | | | |
|---|---|---|---|
| mean | std | <0.05 | <0.01 |

p-values for watermarked images

| | | | | |
|---|---|---|---|---|
| Length | 0.0123 | 0.0277 | 95.74% | 73.02% |
| Angle | 0.0109 | 0.0376 | 93.60% | 85.08% |
| Combined | 0.0011 | 0.0091 | 99.48% | 98.28% |

p-values for clean images

| | | | | |
|---|---|---|---|---|
| Length | 0.5227 | 0.2804 | 4.28% | 1.18% |
| Angle | 0.4958 | 0.2285 | 5.06% | 0.96% |
| Combined | 0.5140 | 0.2286 | 4.96% | 1.28% |

### 4. Imperceptibility Analysis

The watermark invisibility is evaluated by measuring the image quality of watermarked images against the original images. The proposed method can control the image quality by setting the ∈-bound of the perturbation, while DNNOB and SSLWM can target specific PSNR/SSIM values. In contrast, HiDDeN encourages imperceptibility using a discriminator network without a preset quality target. The trained HiDDeN model obtains a PSNR of 32, and thus, for a fair comparison, the proposed method, DNNOB, and SSLWM are set to produce the same PSNR of 32. It is also evaluated at a higher PSNR of 42.

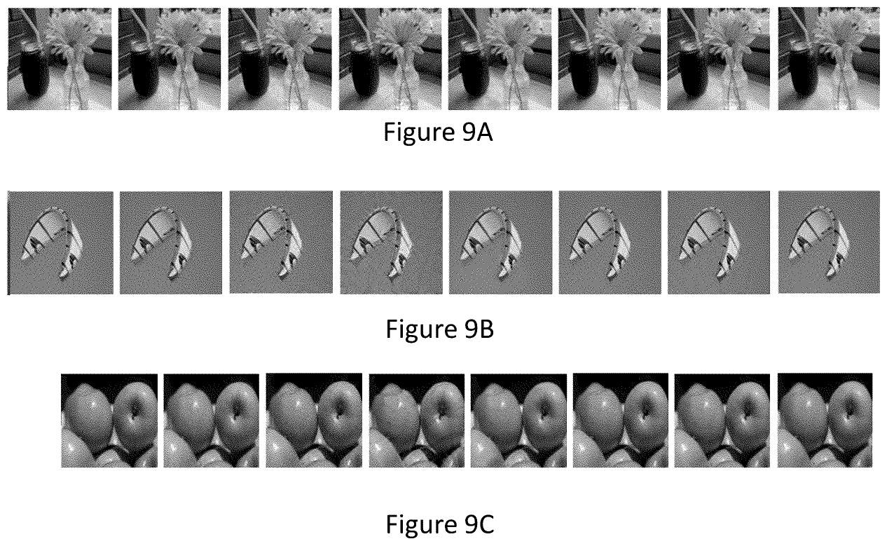

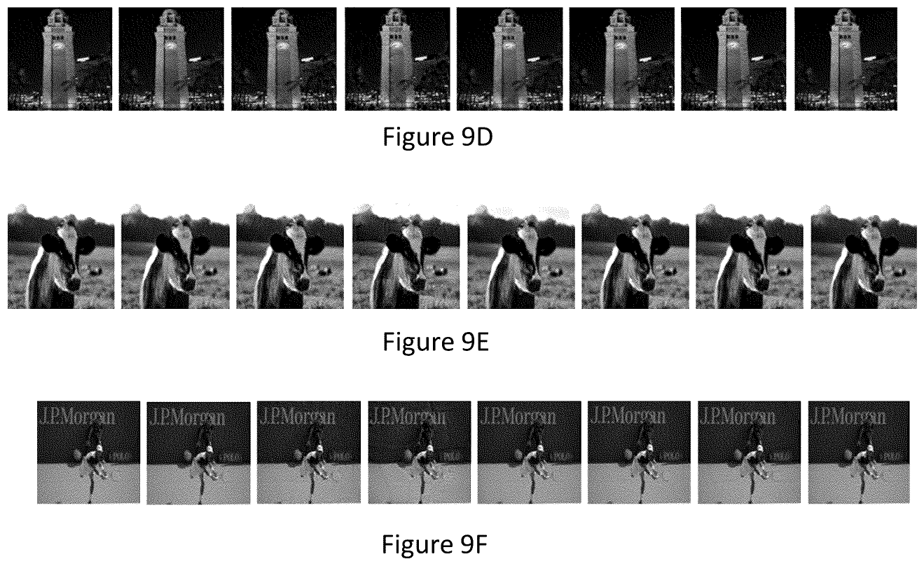

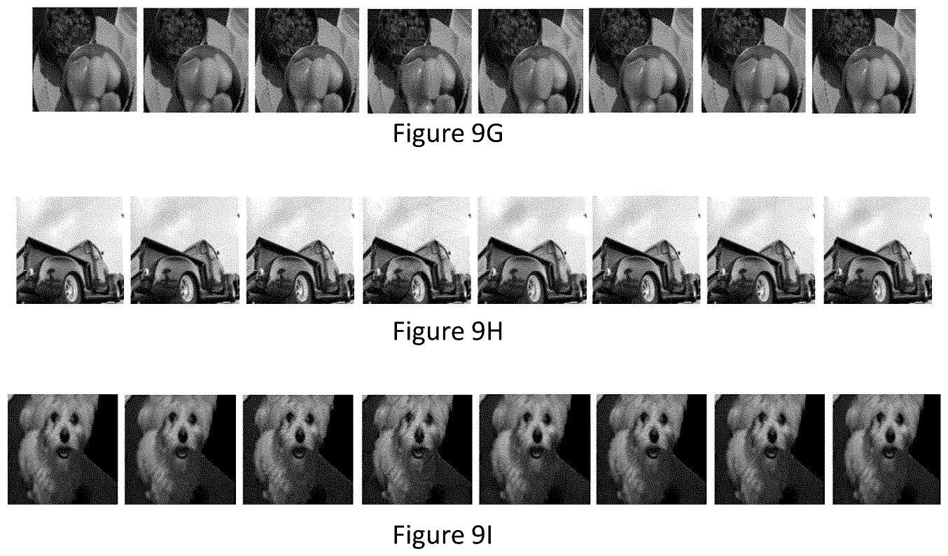

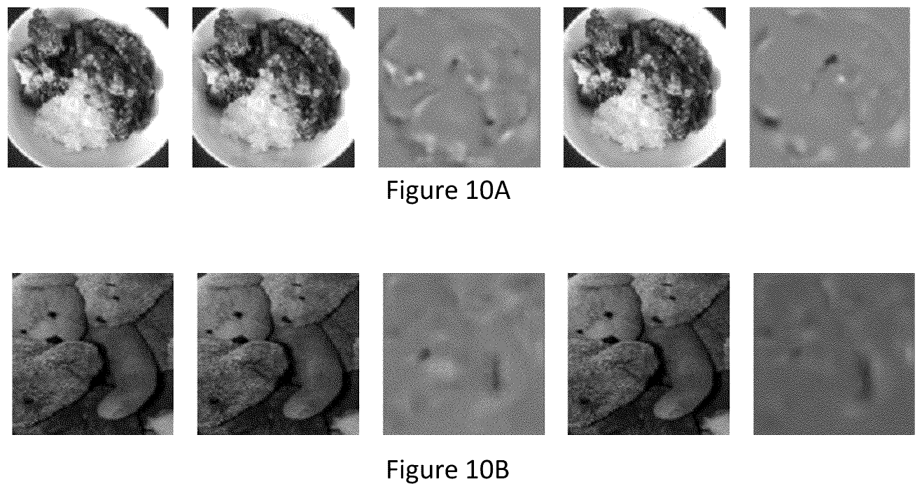

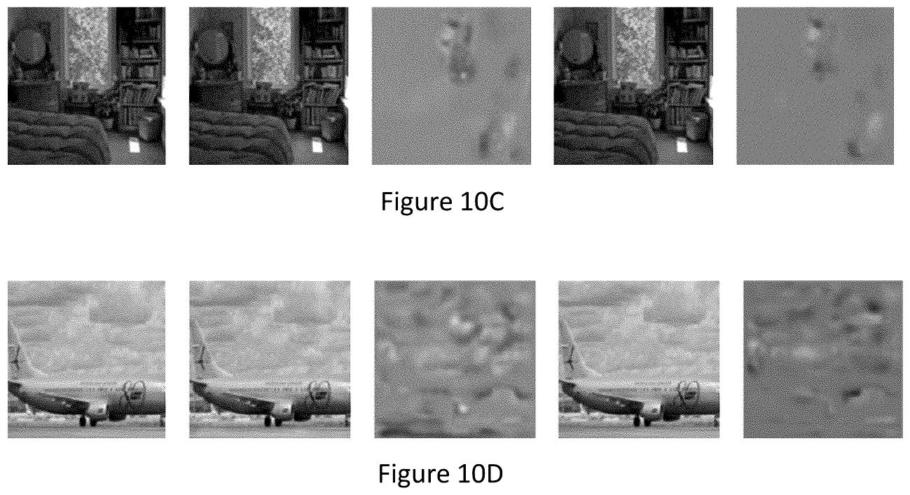

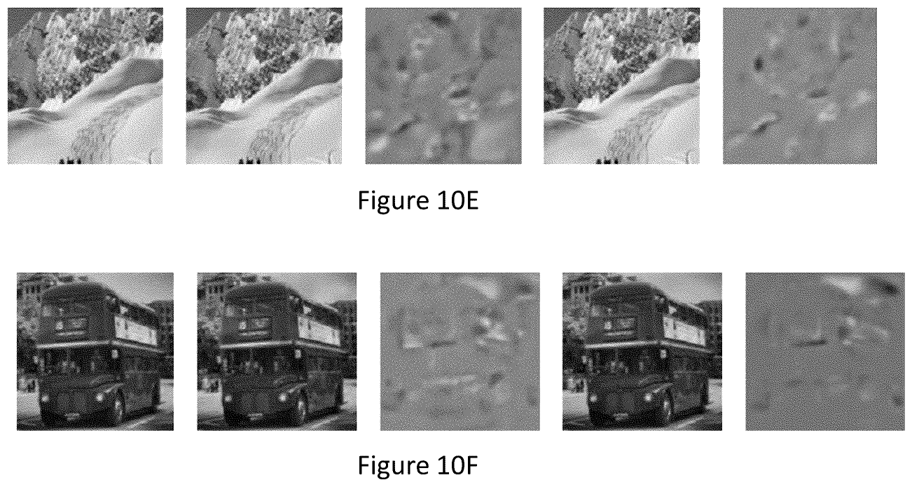

Quantitative and qualitative comparisons are presented in Tab. 5 and FIGS. 9A to 9I and 10A to 10F. FIGS. 9A to 9I show a qualitative comparison of the watermarked images. Similar to Tab. 5, this figure also includes three different models: HiDDeN [22], DNNOB [34], and SSLWM [8]. Both DNNOB and SSLWM, along with the proposed method, are tested under two distinct PSNR values: 32 and 42. In each of FIGS. 9A to 9I, eight figures show original, HiDDeN-32, DNNOB-32, SSLWM-32, the proposed method-32, DNNOB-42, SSLWM-42, the proposed method-42, respectively, from left to right. The observations from FIGS. 9A to 9I reveal that at a PSNR of 32, watermarked images generated by HiDDeN exhibit a slight blur yet remain largely identical to their original counterparts. Images processed by DNNOB display minimal noise, whereas those treated with the ResNet50 approach show faint line noise. In contrast, the proposed method introduces minor color discrepancies in certain small image areas. Notably, when the PSNR is elevated from 32 to 42, these anomalies are significantly reduced, leading to the proposed method producing images virtually indistinguishable from their originals. Additionally, FIGS. 10A to 10F show a broader range of watermarked images generated by the proposed method. In each of FIGS. 10A to 10F, five figures show original image, watermarked-32, watermark-32, watermarked-42, watermark-42, respectively, from left to right.

At PSNR 32, the proposed method achieves higher SSIM scores than other methods, even without SSIM optimization as in SSLWM. Visually, the proposed method minimizes textural distortions, which are produced by SSLWM and DNNOB, while maintaining nearly 100% watermark detection accuracy at a significance level of 0.05. Even at the higher PSNR of 42, the proposed method's image quality SSIM remains superior, with results visually indistinguishable from original images.

TABLE 5
Quantitative comparison of watermark imperceptibility
at two PSNR levels of 32 and 42.

| | PSNR ↑ | SSIM ↑ | MAE ↓ | RMSE ↓ |
|---|---|---|---|---|
| HiDDeN [43] | 31.66 | 0.9531 | 0.0204 | 0.0267 |
| DNN0B-32 [34] | 32.06 | 0.9103 | 0.0195 | 0.0250 |
| SSLWM-32 [8] | 32.11 | 0.9026 | 0.0192 | 0.0248 |
| Ours-32 | 32.56 | 0.9768 | 0.0134 | 0.0237 |
| DNN0B-42 [34] | 41.81 | 0.9859 | 0.0057 | 0.0081 |
| SSLWM-42 [8] | 41.81 | 0.9878 | 0.0061 | 0.0081 |
| Ours-42 | 42.00 | 0.9972 | 0.0038 | 0.0079 |

### 5. Robustness Analysis

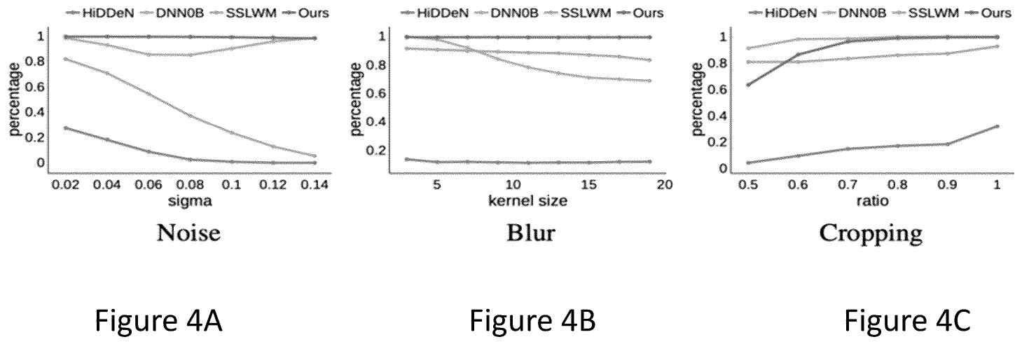

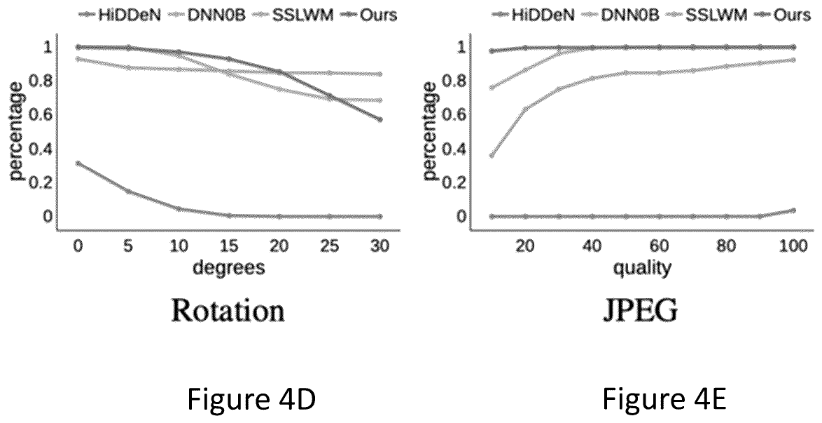

Perturbations commonly used for watermark robustness testing in [1, 2, 8, 22, 34] are selected: Gaussian noise, Gaussian blur, rotation, cropping, and JPEG compression. For each perturbation, the robustness of the model is measured using SDR, i.e., the proportion of watermarked images successfully detected in the test dataset. FIGS. 4A to 4E present the comparative results, which are also summarized in Tab. 1. The proposed method achieves comparable performance to other approaches and is particularly effective against Gaussian noise, Gaussian blur, and JPEG compression, where it outperforms others. However, for rotation and cropping perturbation, the proposed method exhibits a declining trend in performance as the distortion factor intensifies. This is attributed to differences in the spatial distribution of modified pixels in the watermarked images. It is hypothesized that methods like SSLWM and DNNOB distribute the content distortion across the entire image, which leads to advantages when rotating or cropping the watermarked image. In contrast, the proposed method focuses on specific areas, which reduces its robustness if key parts are cropped out or repositioned. This advantage of SSLWM and DNNOB likely comes from the rotation and cropping data-augmentation used when pre-training their DNNs on ImageNet image classification, which could possibly be adopted for training the SKNs in the proposed method.

### 6. Security Analysis

In this section, the security of the proposed watermarking framework is tested. Imagine a scenario involving two users: Alice, the owner of an image, and Bob, a would-be thief, attempting to claim ownership of this image illegally. In this scenario, Bob tries the following three methods.

TABLE 6
Comparison of signature generation security. The percentage
of fake-signatures (both randomly generated and model-
generated) that incorrectly pass the authority check.

| | DNN0B [34] | SSLWM [8] | Ours |
|---|---|---|---|
| randomly | 0.08% | 12.84% | 1.94% |
| model-gen | 100.00% | 100.00% | 4.00% |

Case 1: Bob generates a fake-SKS randomly in hopes of matching the SKS in Alice's watermarked image. To determine the viability of this case, two sets of signatures are randomly produced, one for watermarking testing images and the other as fake signatures to match these testing watermarked images. The results in Tab. 6 (1st row) indicate that the proposed method is more secure than SSLWM. Although DNNOB almost approaches a zero false detection rate, it performs the worst in the watermark removal test of Case 3 below.

Case 2: Bob attempts to steal Alice's signature by examining the DNNs output result on a watermarked image (assuming that Bob knows the watermarking framework). Since DNNOB and SSLWM use models pre-trained from other tasks, Bob can easily obtain their DNNs and thus acquire the signature vector \hat{m} embedded in the watermarked image. Bob can use \hat{m} as his own signature, easily passing the authority check. However, in the proposed framework, Alice's SKN also acts as a secret signature, and different SKNs can be trained using random seeds. Therefore, Bob cannot obtain the weights of Alice's SKN and can only resort to training a separate SKN. The experimental results in Tab. 6 (2nd row) also support this conclusion: watermarked images produced using DNNOB and SSLWM methods are easily matched with fake-signatures, whereas the proposed method exhibits high security in this scenario.

Case 3: Bob tries to remove Alice's watermark from an image by adding his own watermark to the image. In the experiment, three watermarking methods are considered: DNNOB, SSLWM, and the proposed method. For each method, a watermark signature is embedded into an image, acting as Alice's watermark. Then, four different signatures are generated and recursively embedded into the watermarked image, acting as Bob's attack. The final image contains 5 watermarks, one for Alice and 4 from Bob. In each iteration, it is checked whether Alice's watermark can still be detected. For DNNOB and SSLWM, the same pre-trained DNN is used, and different signatures are embedded. For the proposed method embodiment, two versions are tested: 1) the SKN remains the same, and different SKSs are used in each iteration (equivalent to Alice overwriting her own watermark with her SKN); and 2) both the SKN and SKS are changed in each iteration (equivalent to Bob overwriting Alice's watermark with new SKNs).

The results are presented in Tab. 7. Initially when the first signature is introduced to the original image, it is nearly 100% detectable by all three methods. However, adding a second signature led DNNOB to eliminate the first watermark entirely, dropping its detectability to 0%. While SSLWM's method partially preserves the first signature after the second signature is added, the detectability drops the signature in subsequent iterations. In contrast, the proposed method embodiment consistently sustains a high detection rate for a watermark, even after 4 additional watermarks are embedded. Moreover, the proposed method embodiment demonstrates robust performance even when altering both the SKN and SKS.

TABLE 7
Robustness test of watermark preservation against embedding
of multiple overlapping signatures - the detection rate of
the original watermark (No. 1) after the recursive addition
of new watermarks (2 to 5) to the image. Ours(S) means the
SKN is kept the same, and the SKS changes in each iteration,
and Ours(S + N) means both the SKN and SKS vary in each iteration.

| No. Watermarks | 1 | 2 | 3 | 4 | 5 |
|---|---|---|---|---|---|
| DNN0B [34] | 98.50% | 0.00% | 0.00% | 0.00% | 0.00% |
| SSLWM [8] | 92.62% | 60.50% | 27.00% | 19.50% | 12.00% |
| Ours(S) | 99.50% | 99.00% | 98.00% | 99.70% | 99.60% |
| Ours(S + N) | 99.50% | 98.60% | 96.10% | 89.70% | 89.70% |

### 7. Ablation Studies

In this subsection, ablation studies are conducted on a few key components of the proposed framework. Robustness measurements for selected image distortions that demonstrate significant improvements are presented. Also, expanded analysis to include results from a comprehensive range of image distortions is provided. This includes Gaussian noise, Gaussian blur, cropping, rotation, and JPEG compression.

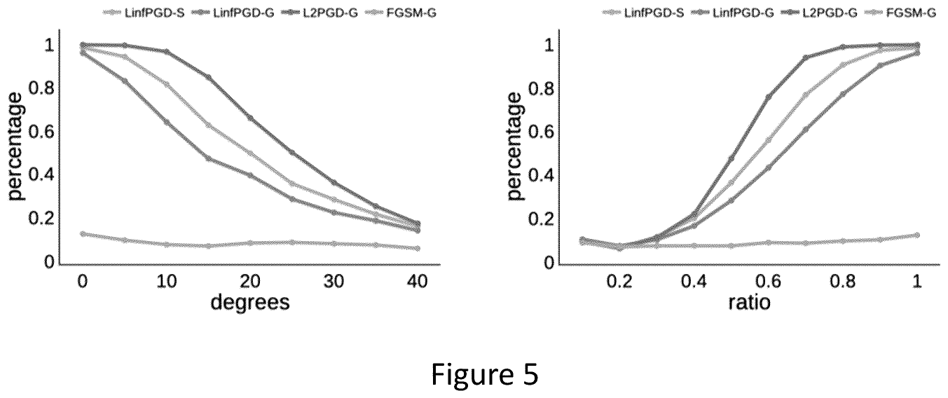

Effect of adversarial attack. Initially, the proposed framework applies the common PGD attack, utilizing the sign of the gradient and the L . . . norm (denoted as LinfPGD-S in FIG. 5). To enhance robustness, the sign of the gradient is subsequently replaced with its actual value (i.e., LinfPGD-G). Furthermore, employing the L2 norm for the perturbation constraint further improves performance (i.e., L2PGD-G). In contrast to these multiple iteration adversarial attacks like PGD, the single-step attack FGSM, modified to use the gradient value (FGSM-G), exhibits the poorest performance. In another study, the proposed framework gradually reduces the AA's perturbation bound e from 5×10⁻² to 10⁻⁵ and plots the PSNR and detection success rate in the Supplemental. As the perturbation strength decreases, the watermark detection rate also drops, but the image quality (PSNR) increases.

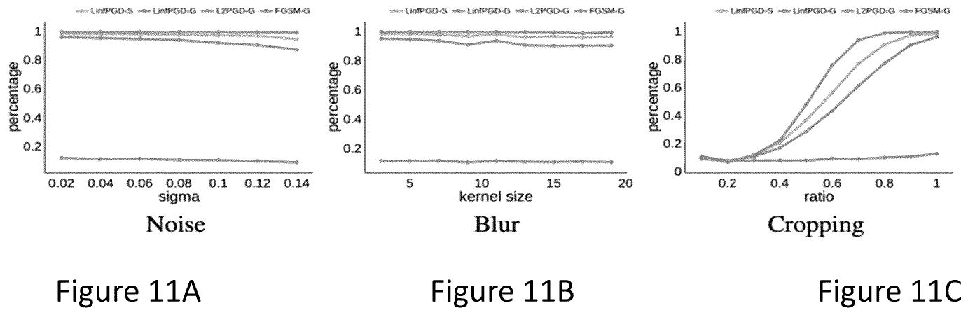

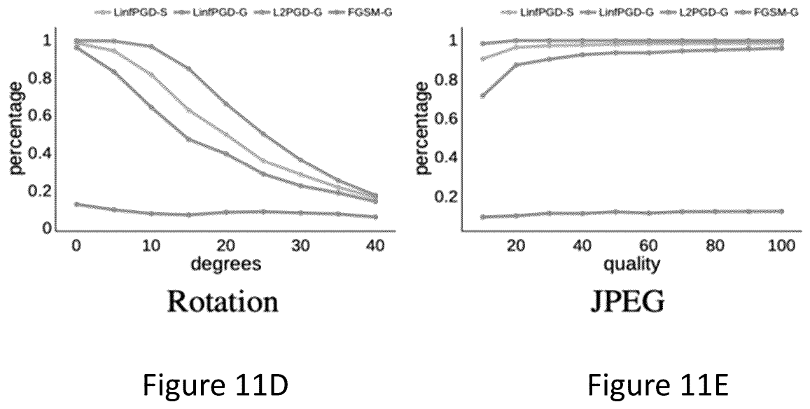

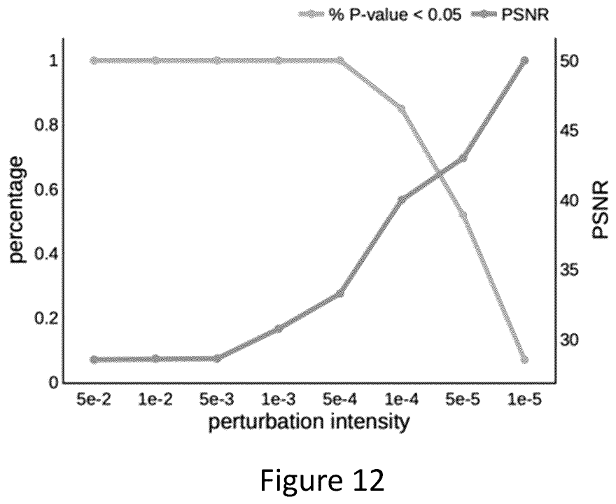

FIGS. 11A to 11E depict the effect of various adversarial attacks on image robustness. It is observed that L2PGD-G achieves superior robustness across the five image distortions tested. Additionally, iterative watermarking methods, such as those in the PGD series, significantly outperform single-step watermarking approaches like FGSM. FIG. 12 shows the effect of perturbation intensities of adversarial attacks (the parameter ∈ in the PGD) on detection rate and image quality. It illustrates the inverse relationship between detection rate and image quality under varying intensities of adversarial JPEG perturbations. As the perturbation intensity decreases, the detection rate drops sharply, while the PSNR, a measure of image quality, increases significantly.

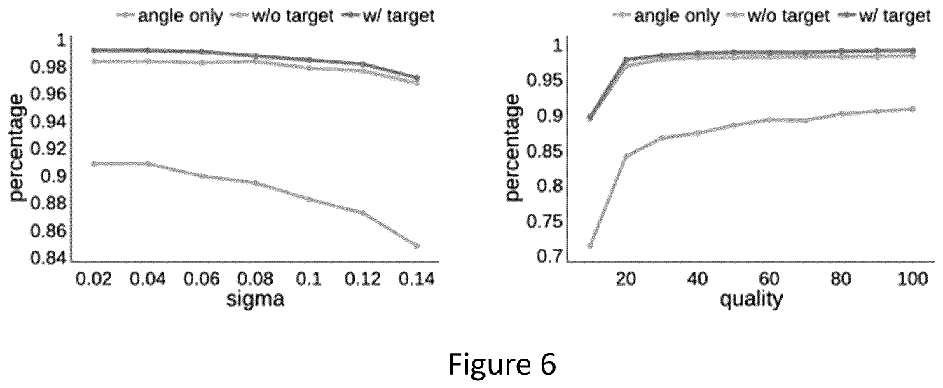

Effect of adversarial loss. The adversarial loss [symbol] _{adv} uses target values of tₗ=63 and tₐ=1 for the length and cosine terms. An adversarial loss can also be defined without a length target value, which aims to increase the length of the output vector. The robustness comparing with and without the target length are shown in FIG. 6. Using the target length has better performance. It is hypothesized that the competition between length and angle terms for modifying pixel values within the limited ∈-bound necessitates setting target values so that once the target length is reached, the remaining capacity is used for adjusting the output direction. Furthermore, experiments using only the angle metric in [symbol] _{adv} (and corresponding HT4A) show that relying solely on angle is marginally less effective.

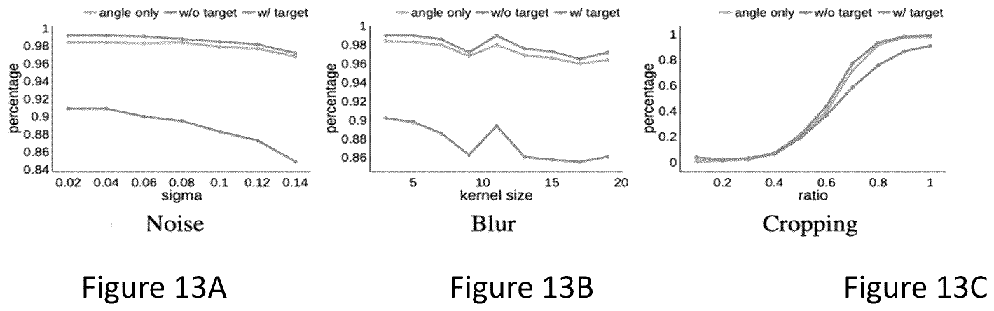

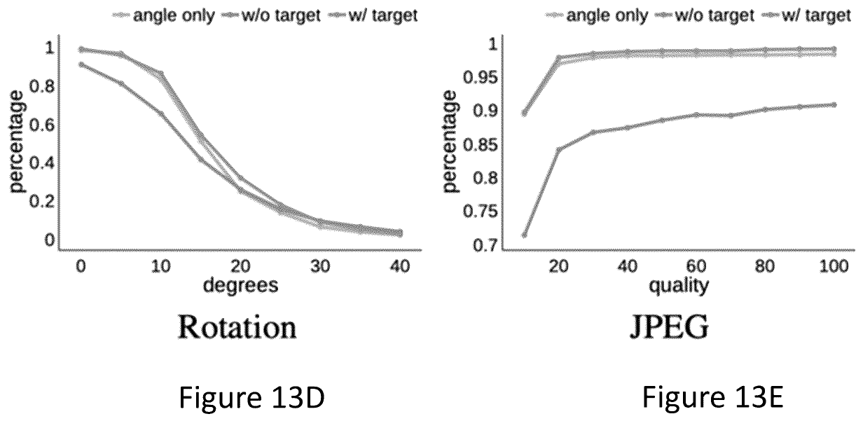

FIGS. 13A to 13E demonstrate the impact on watermark robustness when target length values are included in the adversarial loss [symbol] _{adv}, versus using the angle metric exclusively. Incorporating a target value in [symbol] _{adv} enhances robustness over not specifying a target. Additionally, a combination of length and angle metrics results in a marginally higher detection rate than only using the angle metric.

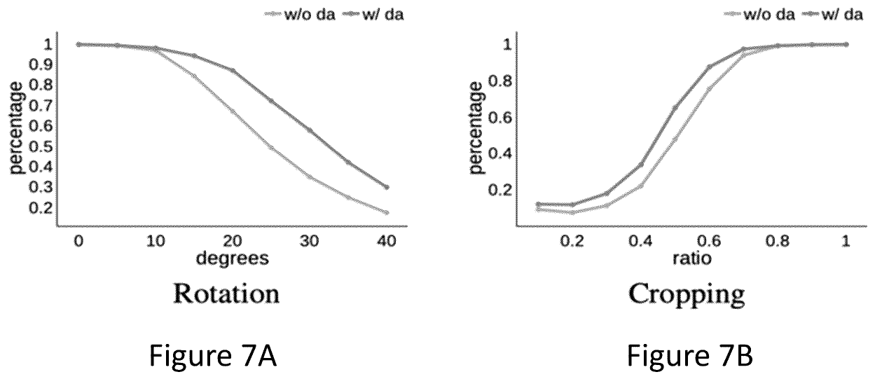

Effect of data augmentation. To enhance the robustness of the watermark, data augmentation operations are also introduced on the image during the watermarking process, as used in [8, 34]. Specifically, in the iterative process of watermarking, data augmentation (rotation and cropping) is randomly performed on the image and then [symbol] _{adv} is recalculated. FIGS. 7A and 7B show that data augmentation can significantly improve the detection rate of watermarks.

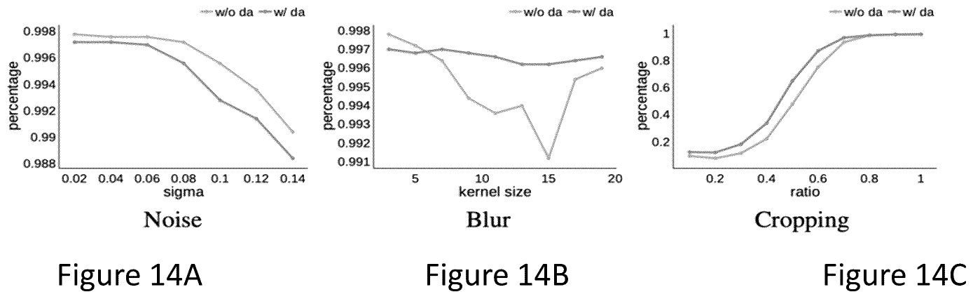

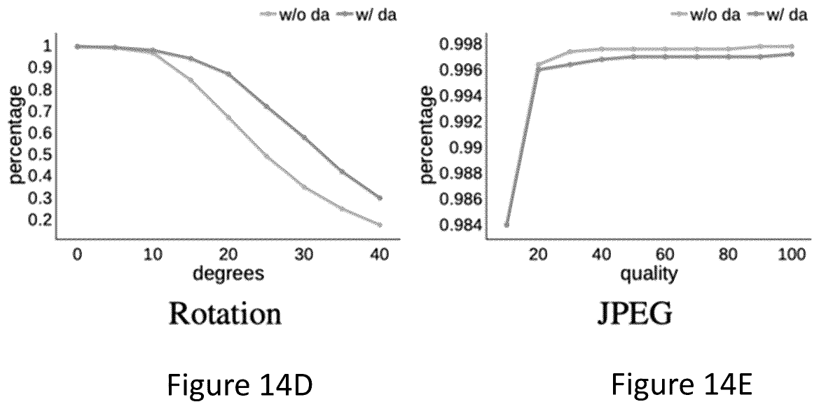

FIGS. 14A to 14E illustrate the impact of incorporating a data augmentation module into the watermarking process. Data augmentation enhances robustness, particularly against Gaussian blur, cropping, and rotation. While the module does not lead to a higher detection rate for Gaussian noise and JPEG compression than methods without it, the detection rates are extremely high, nearing 100%.

### III. Conclusion

There is provided a new watermarking framework based on secret key networks imbued with statistical properties, adversarial attack on these networks to embed watermarks into images, and corresponding hypothesis tests for detecting watermarks with statistical guarantees. To ensure a higher level of watermark security, in addition to using a secret key signature (SKS), a secret key network (SKN) is also introduced. The SKN effectively makes the DNN as a watermarking key. Two potential scenarios are hypothesized that could threaten watermark security and confirm that the proposed methodology surpasses the baselines in terms of security. Moreover, the proposed method embodiment's robustness is enhanced by using targeted adversarial loss and incorporating data augmentation during the watermarking process. Future work will consider using the proposed framework for steganography, where text/image vector embeddings, e.g., CLIP [27], could be used to encode information into the watermark signatures.

Advantages of the embodiments of the invention are as follows.

Enhanced Security through Unique DNNs: Unlike existing methods which often use known linear embedding functions or pre-trained CNNs, the proposed watermarking framework employs a secret-key network (SKN) as a unique, non-linear mapping function. This approach significantly enhances security as the SKN acts as a secret key, making the watermarks unrecognizable by other networks with different weights.

Dual Signature System: The embodiments of the invention utilize two types of signatures: the network SKN and the vector secret key signature (SKS). This dual signature system offers a more versatile and robust watermarking approach. It provides two complementary methods to embed information into images, enhancing both the watermark's secrecy and its capability for different applications like steganography.

Statistical Guarantees and Detector Interpretability: The proposed framework includes hypothesis tests for watermark detection, which leverage the statistical properties of the trained SKN. This not only offers statistical guarantees for the watermark detection but also ensures the explainability of the detector, a feature lacking in many deep learning-based methods.

Improved Imperceptibility and Image Quality: The adversarial attack technique used for embedding the watermark ensures that the modifications are imperceptible, maintaining the aesthetics of the original image. The method surpasses others in image quality metrics like SSIM, ensuring that watermarked images retain high visual quality.

Robustness to Image Distortions: The proposed method embodiment demonstrates superior robustness against various image distortions such as noise, blur, rotation, cropping, and JPEG compression. It achieves high detection rates under these conditions, ensuring the watermark's robust in different scenarios.

Resilience to Security Threats: The proposed framework has been tested against potential security threats, showing significant enhancements in security. For example, it is more resistant to watermark removal attempts and false signature generation, as indicated by lower false rates and higher resistance levels compared to other methods.

Calibrated Detector Guarantees: The SKNs are trained to adhere to a Gaussian output distribution, providing well-calibrated detector guarantees. This is a substantial improvement over other methods that only approximate a Gaussian distribution, enhancing the reliability of the watermark detection process.

### System

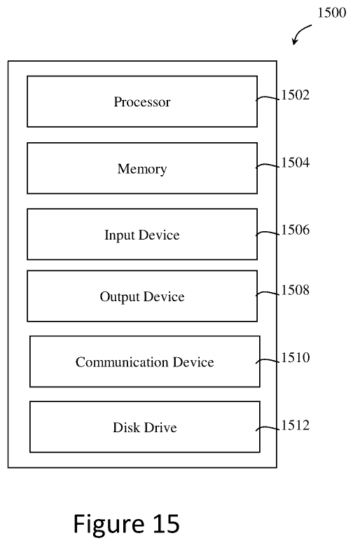

FIG. 15 shows an example information handling system 1500 that can be used to perform one or more of the methods for watermarking images and/or one or more of the methods for detecting a watermark in an image in embodiments of the invention. The information handling system 1500 generally comprises suitable components necessary to receive, store, and execute appropriate computer instructions, commands, and/or codes. The main components of the information handling system 1500 are a processor 1502 and a memory (storage) 1504. The processor 1502 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The memory 1504 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 1504. Computer instructions for executing or facilitating executing the method embodiments of the invention may be stored in the memory 1504. The processor 1502 and memory (storage) 1504 may be integrated or separated (and operably connected). Optionally, the information handling system 1500 further includes one or more input devices 1506. Example of such input device 1506 include: keyboard, mouse, stylus, image scanner, microphone, tactile/touch input device (e.g., touch sensitive screen), image/video input device (e.g., camera), etc. Optionally, the information handling system 1500 further includes one or more output devices 1508. Example of such output device 1508 include: display (e.g., monitor, screen, projector, etc.), speaker, headphone, earphone, printer, additive manufacturing machine (e.g., 3D printer), etc. The display may include a LCD display, a LED/OLED display, or other suitable display, which may or may not be touch sensitive. The information handling system 1500 may further include one or more disk drives 1512 which may include one or more of: solid state drive, hard disk drive, optical drive, flash drive, magnetic tape drive, etc. A suitable operating system may be installed in the information handling system 1500, e.g., on the disk drive 1512 or in the memory 1504. The memory 1504 and the disk drive 1512 may be operated by the processor 1502. Optionally, the information handling system 1500 also includes a communication device 1510 for establishing one or more communication links (not shown) with one or more other computing devices, such as servers, personal computers, terminals, tablets, phones, watches, IoT devices, or other wireless computing devices. The communication device 1510 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, above 5G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 1502, the memory 1504 (optionally the input device(s) 1506, the output device(s) 1508, the communication device(s) 1510 and the disk drive(s) 1512, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. A person skilled in the art would appreciate that the information handling system 1500 shown in FIG. 15 is merely an example and that the information handling system 1500 can in other embodiments have different configurations (e.g., include additional components, has fewer components, etc.).

Although not required, one or more embodiments described with reference to the Figures can be implemented as an application programming interface (API) or as a series of libraries for use by a developer or can be included within another software application, such as a terminal or computer operating system or a portable computing device operating system. In one or more embodiments, as program modules include routines, programs, objects, components, and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings).

### REFERENCES

[1] Mahdi Ahmadi, Alireza Norouzi, Nader Karimi, Shadrokh Samavi, and Ali Emami. ReDMark: Framework for residual diffusion watermarking based on deep networks. Expert Systems with Applications, 146:113157, 2020.
[2] Shumeet Baluja. Hiding Images in Plain Sight: Deep Steganography. In Advances in Neural Information Processing Systems, 2017.
[3] Chin-Chen Chang, Piyu Tsai, and Chia-Chen Lin. SVD based digital image watermarking scheme. Pattern Recognition Letters, 26 (10): 1577-1586, 2005.
[4] Abbas Cheddad, Joan Condell, Kevin Curran, and Paul Mc Kevitt. Digital image steganography: Survey and analysis of current methods. Signal processing, 90 (3): 727-752, 2010.
[5] Pedro Comesana, Neri Merhav, and Mauro Barni. Asymptotically optimum universal watermark embedding and detection in the high-snr regime. IEEE Transactions on Information Theory, page 2804-2815, 2010.
[6] DC Dowson and BV666017 Landau. The fréchet distance between multivariate normal distributions. Journal of multivariate analysis, 12 (3): 450-455, 1982.
[7] Jianwei Fei, Zhihua Xia, Benedetta Tondi, and Mauro Barni. Supervised gan watermarking for intellectual property protection. In 2022 IEEE International Workshop on Information Forensics and Security (WIFS), pages 1-6, 2022.
[8] Pierre Fernandez, Alexandre Sablayrolles, Teddy Furon, Hervé Jégou, and Matthijs Douze. Watermarking images in self-supervised latent spaces. In ICASSP 2022-2022 IEEE International Conference on Acoustics, Speech and Signal Processing (ICASSP), pages 3054-3058, 2022.
[9] Teddy Furon and Patrick Bas. Broken arrows. EURASIP Journal on Information Security, page 597040, 2008.
[10] Clark R Givens and Rae Michael Shortt. A class of wasserstein metrics for probability distributions. Michigan Mathematical Journal, 31 (2): 231-240, 1984.
[11] Zhenyu Guan, Junpeng Jing, Xin Deng, Mai Xu, Lai Jiang, Zhou Zhang, and Yipeng Li. DeepMIH: Deep Invertible Network for Multiple Image Hiding. IEEE Transactions on Pattern Analysis and Machine Intelligence, pages 372-390, 2023.
[12] Kaiming He, Xiangyu Zhang, Shaoqing Ren, and Jian Sun. Deep residual learning for image recognition. In Proceedings of the IEEE conference on computer vision and pattern recognition, pages 770-778, 2016.
[13] Hao Huang, Yongtao Wang, Zhaoyu Chen, Yuze Zhang, Yuheng Li, Zhi Tang, Wei Chu, Jingdong Chen, Weisi Lin, and Kai-Kuang Ma. CMUA-Watermark: A Cross-Model Universal Adversarial Watermark for Combating Deepfakes. Proceedings of the AAAI Conference on Artificial Intelligence, 36 (1): 989-997, 2022.
[14] Xiaojun Jia, Xingxing Wei, Xiaochun Cao, and Xiaoguang Han. Adv-watermark: A Novel Watermark Perturbation for Adversarial Examples. In Proceedings of the 28th ACM International Conference on Multimedia, pages 1579-1587, 2020.
[15] Junpeng Jing, Xin Deng, Mai Xu, Jianyi Wang, and Zhenyu Guan. HiNet: deep image hiding by invertible network. In Proceedings of the IEEE/CVF international conference on computer vision, pages 4733-4742, 2021.
[16] Bahjat Kawar, Shiran Zada, Oran Lang, Omer Tov, Huiwen Chang, Tali Dekel, Inbar Mosseri, and Michal Irani. Imagic: Text-based real image editing with diffusion models. In Proceedings of the IEEE/CVF Conference on Computer Vision and Pattern Recognition, pages 6007-6017, 2023.
[17] D. Kundur and D. Hatzinakos. Digital watermarking using multiresolution wavelet decomposition. In Proceedings of the 1998 IEEE International Conference on Acoustics, Speech and Signal Processing, ICASSP '98 (Cat. No. 98CH36181), pages 2969-2972 vol. 5, 1998.
[18] C. Lanczos. A precision approximation of the gamma function. Journal of the Society for Industrial and Applied Mathematics Series B Numerical Analysis, 1 (1): 86-96, 1964.
[19] Yao Li, Minhao Cheng, Cho-Jui Hsieh, and Thomas C M Lee. A review of adversarial attack and defense for classification methods. The American Statistician, 76 (4): 329-345, 2022.
[20] Tsung-Yi Lin, Michael Maire, Serge Belongie, James Hays, Pietro Perona, Deva Ramanan, Piotr Doll′ar, and C Lawrence Zitnick. Microsoft coco: Common objects in context. In Computer Vision-ECCV 2014: 13th European Conference, Zurich, Switzerland, Sep. 6-12, 2014, Proceedings, Part V 13, pages 740-755, 2014.
[21] Yang Liu, Mengxi Guo, Jian Zhang, Yuesheng Zhu, and Xiaodong Xie. A Novel Two-stage Separable Deep Learning Framework for Practical Blind Watermarking. In Proceedings of the 27th ACM International Conference on Multimedia, pages 1509-1517, 2019.
[22] Xiyang Luo, Ruohan Zhan, Huiwen Chang, Feng Yang, and Peyman Milanfar. Distortion Agnostic Deep Watermarking. In 2020 IEEE/CVF Conference on Computer Vision and Pattern Recognition (CVPR), pages 13545-13554, Seattle, WA, USA, 2020.
[23] Aleksander Madry, Aleksandar Makelov, Ludwig Schmidt, Dimitris Tsipras, and Adrian Vladu. (PGD) Towards Deep Learning Models Resistant to Adversarial Attacks, 2019.
[24] Ingram Olkin and Friedrich Pukelsheim. The distance between two random vectors with given dispersion matrices. Linear Algebra and its Applications, 48:257-263, 1982.
[25] J. J. K. O'Ruanaidh and T. Pun. Rotation, scale and translation invariant digital image watermarking. In Proceedings of International Conference on Image Processing, pages 536539 vol. 1, 1997.
[26] Vidyasagar M Potdar, Song Han, and Elizabeth Chang. A survey of digital image watermarking techniques. In INDIN′05. 2005 3rd IEEE International Conference on Industrial Informatics, 2005., pages 709-716, 2005.
[27] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pages 8748-8763, 2021.
[28] Robin Rombach, Andreas Blattmann, Dominik Lorenz, Patrick Esser, and Bjorn Ommer. High-resolution image synthesis with latent diffusion models. In Proceedings of the IEEE/CVF conference on computer vision and pattern recognition, pages 10684-10695, 2022.
[29] Erez Sabbag and Neri Merhav. Optimal watermark embedding and detection strategies under limited detection resources. In 2006 IEEE International Symposium on Information Theory, 2006.
[30] Christian Szegedy, Wojciech Zaremba, Ilya Sutskever, Joan Bruna, Dumitru Erhan, Ian Goodfellow, and Rob Fergus. Intriguing properties of neural networks. arXiv preprint arXiv: 1312.6199, 2013.
[31] James Theiler. Combining statistical tests by multiplying p-values. Astrophysics and Radiation Measurements Group, NIS-2, 2004.
[32] Thanh Van Le, Hao Phung, Thuan Hoang Nguyen, Quan Dao, Ngoc Tran, and Anh Tran. Anti-DreamBooth: Protecting users from personalized text-to-image synthesis, 2023.
[33] Vedran Vukotic, Vivien Chappelier, and Teddy Furon. Are deep neural networks good for blind image watermarking. In 2018 IEEE International Workshop on Information Forensics and Security (WIFS), 2018.
[34] Vedran Vukotic, Vivien Chappelier, and Teddy Furon. Are classification deep neural networks good for blind image watermarking? Entropy, 22 (2): 198, 2020.
[35] Wenbo Wan, Jun Wang, Yunming Zhang, Jing Li, Hui Yu, and Jiande Sun. A comprehensive survey on robust image watermarking. Neurocomputing, 488:226-247, 2022.
[36] Yuxin Wen, John Kirchenbauer, Jonas Geiping, and Tom Goldstein. Tree-Ring Watermarks: Fingerprints for Diffusion Images that are Invisible and Robust. arXiv preprint arXiv: 2305.20030, 2023.
[37] Eric Wengrowski and Kristin Dana. Light Field Messaging With Deep Photographic Steganography. In 2019 IEEE/CVF Conference on Computer Vision and Pattern Recognition (CVPR), pages 1515-1524, 2019.
[38] Edwin B Wilson and Margaret M Hilferty. The distribution of chi-square. Proceedings of the National Academy of Sciences, 17 (12): 684-688, 1931.
[39] Han Xu, Yao Ma, Hao-Chen Liu, Debayan Deb, Hui Liu, Ji-Liang Tang, and Anil K Jain. Adversarial attacks and defenses in images, graphs and text: A review. International Journal of Automation and Computing, 17:151-178, 2020.
[40] Youmin Xu, Chong Mou, Yujie Hu, Jingfen Xie, and Jian Zhang. Robust Invertible Image Steganography. In 2022 IEEE/CVF Conference on Computer Vision and Pattern Recognition (CVPR), pages 7865-7874, 2022.
[41] M.M. Yeung and F. Mintzer. An invisible watermarking technique for image verification. In Proceedings of International Conference on Image Processing, pages 680-683 vol. 2, 1997.
[42] Yunqing Zhao, Tianyu Pang, Chao Du, Xiao Yang, NgaiMan Cheung, and Min Lin. A Recipe for Watermarking Diffusion Models, 2023.
[43] Jiren Zhu, Russell Kaplan, Justin Johnson, and Li Fei-Fei. HiDDeN: Hiding Data With Deep Networks. In Computer Vision-ECCV 2018, Lecture Notes in Computer Science, pages 682-697. Springer, 2018.

1. A computer-implemented method for watermarking images, comprising:
providing a secret key network (SKN) that is adapted to output a standard multivariate normal (SMVN) distribution for a given input image distribution;
applying an input image to the SKN;
generating a secret key signature (SKS) as a real vector; and
embedding a watermark in the input image by using an adversarial attack to modify the input image in a manner that aligns the SKN's output with the SKS.

2. The computer-implemented method of claim 1, wherein the step of providing the SKN comprises training a deep neural network (DNN) to function as the SKN via a generation loss (Gen-Loss) which is designed to train the SKN's output to follow an SMVN distribution.

3. The computer-implemented method of claim 1, wherein the SKN serves as a unique, non-linear mapping function.

4. The computer-implemented method of claim 1, wherein the SKN is based on a modified ResNet18 architecture with linear activation in its final layer to map the input image to the real vector.

5. The computer-implemented method of claim 1, wherein the SKS follows normal distribution properties and has a cosine value greater than 0 with an angle formed with an output vector of the input image.

6. The computer-implemented method of claim 1, wherein in the step of embedding the watermark, the SKN's output is made in the same direction as the SKS, with a length extended such that it is unlikely to be a sample from the SMVN.

7. The computer-implemented method of claim 1, wherein the step of embedding the watermark further comprises adjusting a length and an angle of the SKN output to match predefined targets via a watermarking loss (WM-Loss) and the adversarial attack.

8. The computer-implemented method of claim 7, wherein the step of adjusting the length and the angle of the SKN output comprises extending the length of the SKN output toward a length target and minimizing the angle between the SKN output and the SKS to be a target cosine value.

9. The computer-implemented method of claim 7, wherein the adversarial attack iteratively adds a gradient value computed by the WM-loss and clipped within a boundary limited by a scale factor into the watermarked image.

10. A computer-implemented method for detecting a watermark in an image, comprising:
applying a secret key network (SKN) to a potentially watermarked image to extract a recovered signature; and
performing statistical hypothesis tests on a length and an angle of the recovered signature to determine the watermark's presence in the potentially watermarked image, wherein the potentially watermarked image is watermarked by the computer-implemented method of claim 1.

11. The computer-implemented method of claim 10, wherein the statistical hypothesis tests comprise two hypothesis tests, and the two hypothesis tests comprise a first hypothesis test to work on the length of the recovered signature, testing if the vector is unlikely to be a sample from the SMVN, and a second hypothesis test to work on the angle, testing if the direction of the recovered signature matches the original SKS.

12. The computer-implemented method of claim 11, wherein the first hypothesis test accesses the uniqueness of the SKN by calculating a first probability of the output vector not following the SMVN distribution, and the second hypothesis test verifies the uniqueness of the SKS by calculating a second probability of the output vector and the SKS having the same direction.

13. The computer-implemented method of claim 10, further comprising a step of statistically determining a probability of false positives in watermark detection.

14. The computer-implemented method of claim 12, further comprising a step of statistically determining a probability of false positives in watermark detection,
wherein the step of statistically determining the probability of false positives comprises obtaining a combined probability of the first probability and the second probability, and determining if the combined probability is smaller than a predefined significance level, wherein the predefined significance level represents a false positive rate.

15. The computer-implemented method of claim 14, wherein determining the combined probability to be smaller than the predefined significance level indicates successful detection of the watermark's presence.

16. A system for watermarking images, comprising:
one or more processors; and
a memory storing one or more programs configured to be executed by the one or more processors, the one or more programs including instructions for performing or facilitating performing of the computer-implemented method of claim 1.

17. A non-transitory computer readable medium having instructions stored thereon which, when executed by one or more processors, cause the one or more processors to execute the computer-implemented method of claim 1.
